(19) United States
(12) Patent Application Publication
(10) Pub. No.: US 2016/0029027 A1
(43) Pub. Date: Jan. 28, 2016

(54) DEVICE AND METHOD FOR PROCESSING IMAGE

(71) Applicants: Samsung Electronics Co., Ltd., Suwon-si (KR); Korea University Of Technology And Education Industry-University Cooperation Foundation, Cheonan-si (KR)

(72) Inventors: Sriharsha KATAMANENI, Suwon-si (KR); Jae-Won CHOI, Suwon-si (KR); Kang-Sun CHOI, Cheonan-si (KR); Jae-Hun CHO, Suwon-si (KR); Trang VU, Suwon-si (KR); Yong-Man LEE, Seongnam-si (KR); Dong-Kyoon HAN, Seongnam-si (KR)

(21) Appl. No.: 14/807,443

(22) Filed: Jul. 23, 2015

(30) Foreign Application Priority Data
Jul. 23, 2014 (KR) 10-2014-0093296

(51) Int. Cl. H04N 19/176; H04N 19/196

(52) U.S. Cl. CPC H04N 19/176; H04N 19/196

(57) ABSTRACT

An apparatus and a method for applying an independent compression mode for encoding on each data block constituting an image frame in an encoder provided in an image processing device are provided. To that end, at least one data block is encoded based on each of a plurality of specified compression modes, and at least one data block corresponding to each of the plurality of specified compression modes is reconfigured based on at least in part on each of the plurality of specified compression modes. An inter-data difference corresponding to each of the plurality of specified compression modes is determined based on the at least one data block and a data block obtained by reconfiguring the at least one data block, and at least one compression mode is selected from the plurality of specified compression modes based on at least in part on each of the inter-data difference.

### CROSS-REFERENCE TO RELATED APPLICATION(S)

This application claims the benefit under 35 U.S.C. §119(a) of a Korean patent application filed on Jul. 23, 2014 in the Korean Intellectual Property Office and assigned Serial number. 10-2014-0093296, the entire disclosure of which is hereby incorporated by reference.

### JOINT RESEARCH AGREEMENT

The present disclosure was made by or on behalf of the below listed parties to a joint research agreement. The joint research agreement was in effect on or before the date the present disclosure was made and the present disclosure was made as a result of activities undertaken within the scope of the joint research agreement. The parties to the joint research agreement are 1) SAMSUNG ELECTRONICS CO., LTD. and 2) KOREA UNIVERSITY OF TECHNOLOGY AND EDUCATION INDUSTRY-UNIVERSITY COOPERATION FOUNDATION.

### TECHNICAL FIELD

The present disclosure relates to an image processing device and a method for performing image compression in data block units. More particularly, the present disclosure relates to a method for applying an independent compression mode to encoding on each data block constituting an image frame in an encoder provided in an image processing device.

### BACKGROUND

Recent broadcast services have been integrated with communication services and thus image communication services become commonplace. Image communication services accelerate the spread of broad band networks for fast information transmission as well as terminals enabling high-speed and mass information processing.

Image processing results in image communication-enabled terminals consuming more power. More particularly, the resolution of images to be processed by the portable terminal may be a major factor to determine the power consumed upon display. For example, the power consumed when the portable terminal displays an image increases proportional to the resolution of the image.

The increased image resolution leads to an increase in bandwidth of the terminal or network to carry information on the image to be processed. For instance, the bandwidth for transmitting frames from an application processor (AP) in a portable terminal to a display device increases in proportion to display resolution.

Most of information processing devices typically adopt various compressing and uncompressing (also called “restoration”) techniques to reduce information to be processed. The compression and restoration techniques enable efficient use of information recording media and easier information transfer.

Generally, the quality of a compressed image may be determined by the type of a compression mode used for encoding data blocks. For example, data blocks may be encoded using a compression scheme predicted to present a minimized compression error. Accordingly, there is ongoing research and development to obtain high image quality by selecting a compression mode predicted to present a minimized compression error and encoding data blocks using the selected compression mode.

Therefore, a need exists for a device and a method for applying an independent compression mode to encoding on each data block constituting an image frame in an encoder provided in an image processing device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a device and a method for applying an independent compression mode to encoding on each data block constituting an image frame in an encoder provided in an image processing device.

According to an embodiment of the present disclosure, there may be provided a device and a method using a compression mode with a minimum error rate to compress data blocks obtained by splitting an image frame into a certain size in an encoder provided in an image processing device.

According to an embodiment of the present disclosure, there may be provided a device and a method for performing compression in data block units using each of a plurality of compression modes in an encoder provided in an image processing device and determining a compression mode for a corresponding data block based on an error rate calculated for a data block reconfigured after the compression.

According to an embodiment of the present disclosure, there may be provided a device and a method for newly proposing the operation of each of a plurality of optimized compression modes to calculate an error rate corresponding to a data block in an encoder provided in an image processing device.

In accordance with an aspect of an embodiment of the present disclosure, a device is provided. The device includes an encoding module configured to encode at least one data block based on each of a plurality of specified compression modes, a reconfiguration module configured to reconfigure the at least one data block corresponding to each of the plurality of specified compression modes based at least in part on each of the plurality of specified compression modes, a determination module configured to determine an inter-data difference corresponding to each of the plurality of specified compression modes using the at least one data block and a data block obtained by reconfiguring the at least one data block, and a selection module configured to select at least one compression mode from the plurality of specified compression modes based at least in part on each of the inter-data difference.

In accordance with an aspect of an embodiment of the present disclosure, a method is provided. The method includes encoding at least one data block based on each of a plurality of specified compression modes, reconfiguring the at least one data block corresponding to each of the plurality of specified compression modes using compressed bitstreams generated by each of the plurality of specified compression modes, calculating an inter-data difference corresponding to each of the plurality of specified compression modes using the data block reconfigured corresponding to each of the plurality of specified compression modes and the at least one data block, and selecting a compression mode with a minimum difference among differences calculated corresponding to each of the plurality of specified compression modes.

According to embodiments of the present disclosure, a data block may be encoded by a compression mode that allows for reconfiguration of the data block with a minimized error, thus leading to an enhancement in compression efficiency of compressed images, together with a minimized deterioration of restored images.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an electronic device in a network environment according to an embodiment of the present disclosure;

FIG. 2 is a block diagram illustrating a configuration of an electronic device according to an embodiment of the present disclosure;

FIG. 3 is a block diagram illustrating a configuration of a program module according to an embodiment of the present disclosure;

FIG. 4 illustrates a configuration of an image processing device according to an embodiment of the present disclosure;

FIG. 5 illustrates an image processing device according to an embodiment of the present disclosure;

FIG. 6 illustrates a configuration of an encoder according to an embodiment of the present disclosure;

FIG. 7 is a flowchart illustrating a flow of control performed by an image compressing device according to an embodiment of the present disclosure;

FIG. 8 illustrates a compressed bitstream output per compression mode by an encoder according to an embodiment of the present disclosure;

FIG. 9 illustrates a prediction table according to an embodiment of the present disclosure;

FIG. 10 is a flowchart illustrating a subroutine as per compression mode 1 in an encoder according to an embodiment of the present disclosure;

FIGS. 11A, 11B, 11C, and 11D illustrate methods of performing spatial prediction on selected sub data blocks according to an embodiment of the present disclosure;

FIG. 12 illustrates a compressed bitstream generated by an encoder based on each compression mode according to an embodiment of the present disclosure;

FIG. 13 is a flowchart illustrating a subroutine as per compression mode 2 in an encoder according to an embodiment of the present disclosure;

FIG. 14 illustrates a degree of error when encoding is performed in compression mode 2 according to an embodiment of the present disclosure;

FIG. 15 illustrates a method of obtaining a vector for error correction in compression mode 2 according to an embodiment of the present disclosure;

FIG. 16 illustrates a compressed bitstream obtained by performing encoding in compression mode 2 according to an embodiment of the present disclosure;

FIG. 17 is a flowchart illustrating a subroutine as per compression mode 3 in an encoder according to an embodiment of the present disclosure;

FIG. 18 illustrates obtaining a seed value or representative value (RV) value upon encoding in compression mode 3 according to an embodiment of the present disclosure;

FIG. 19 illustrates, upon encoding in compression mode 3, bits being distributed in four representative values in scalar quantization according to an embodiment of the present disclosure;

FIG. 20 illustrates a method of reconfiguring pixels by interpolation upon encoding in compression mode 3 according to an embodiment of the present disclosure;

FIG. 21 illustrates a compressed bitstream obtained by performing encoding in compression mode 3 according to an embodiment of the present disclosure;

FIG. 22 is a flowchart illustrating a subroutine as per compression mode 4 in an encoder according to an embodiment of the present disclosure; and

FIG. 23 illustrates a compressed bitstream obtained by performing encoding in compression mode 4 according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

As used herein, the terms “have,” “may have,” “include,” or “may include” a feature (e.g., a number, a function, an operation, or a component, such as a part) indicate the existence of the feature and do not exclude the existence of other features.

As used herein, the terms “A or B,” “at least one of A and/or B,” or “one or more of A and/or B” may include all possible combinations of A and B. For example, “A or B,” “at least one of A and B,” “at least one of A or B” may indicate all of (1) including at least one A, (2) including at least one B, or (3) including at least one A and at least one B.

As used herein, the terms “first” and “second” may modify various components regardless of importance and do not limit the components. These terms are only used to distinguish one component from another. For example, a first user device and a second user device may indicate different user devices from each other regardless of the order or importance of the devices. For example, a first component may be denoted a second component, and vice versa without departing from the scope of the present disclosure.

It will be understood that when an element (e.g., a first element) is referred to as being (operatively or communicatively) “coupled with/to,” or “connected with/to” another element (e.g., a second element), it can be coupled or connected with/to the other element directly or via a third element. In contrast, it will be understood that when an element (e.g., a first element) is referred to as being “directly coupled with/to” or “directly connected with/to” another element (e.g., a second element), no other element (e.g., a third element) intervenes between the element and the other element.

As used herein, the terms “configured (or set) to” may be interchangeably used with the terms “suitable for,” “having the capacity to,” “designed to,” “adapted to,” “made to,” or “capable of” depending on circumstances. The term “configured (or set) to” does not essentially mean “specifically designed in hardware to.” Rather, the term “configured to” may mean that a device can perform an operation together with another device or parts. For example, the term “processor configured (or set) to perform A, B, and C” may mean a generic-purpose processor (e.g., a CPU or application processor) that may perform the operations by executing one or more software programs stored in a memory device or a dedicated processor (e.g., an embedded processor) for performing the operations.

The terms as used herein are provided merely to describe some embodiments thereof, but not to limit the scope of other embodiments of the present disclosure. It is to be understood that the singular forms “a,” “an,” and “the” include plural references unless the context clearly dictates otherwise. All terms including technical and scientific terms used herein have the same meaning as commonly understood by one of ordinary skill in the art to which the embodiments of the present disclosure belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In some cases, the terms defined herein may be interpreted to exclude embodiments of the present disclosure.

For example, examples of the electronic device according to embodiments of the present disclosure may include at least one of a smartphone, a tablet personal computer (PC), a mobile phone, a video phone, an e-book reader, a desktop PC, a laptop computer, a netbook computer, a workstation, a PDA (personal digital assistant), a portable multimedia player (PMP), a a moving picture experts group (MPEG-1 or MPEG-2) audio layer III (MP3) player, a mobile medical device, a camera, or a wearable device (e.g., smart glasses, a head-mounted device (HMD), electronic clothes, an electronic bracelet, an electronic necklace, an electronic appcessory, an electronic tattoo, a smart mirror, or a smart watch).

According to an embodiment of the present disclosure, the electronic device may be a smart home appliance. For example, examples of the smart home appliance may include at least one of a television, a digital video disk (DVD) player, an audio player, a refrigerator, an air conditioner, a cleaner, an oven, a microwave oven, a washer, a drier, an air cleaner, a set-top box, a home automation control panel, a security control panel, a TV box (e.g., Samsung HomeSync™, Apple TV™, or Google TV™), a gaming console (Xbox™, PlayStation™), an electronic dictionary, an electronic key, a camcorder, or an electronic picture frame.

According to an embodiment of the present disclosure, examples of the electronic device may include at least one of various medical devices (e.g., diverse portable medical measuring devices (a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, an sailing electronic device (e.g., a sailing navigation device or a gyro compass), avionics, security devices, vehicular head units, industrial or home robots, automatic teller's machines (ATMs), point of sales (POS) devices, or Internet of Things devices (e.g., a bulb, various sensors, an electric or gas meter, a sprinkler, a fire alarm, a thermostat, a street light, a toaster, fitness equipment, a hot water tank, a heater, or a boiler).

According to various embodiments of the disclosure, examples of the electronic device may at least one of furniture, part of a building/structure, an electronic board, an electronic signature receiving device, a projector, or various measurement devices (e.g., devices for measuring water, electricity, gas, or electromagnetic waves).

According to an embodiment of the present disclosure, the electronic device may be one or a combination of the above-listed devices. According to an embodiment of the present disclosure, the electronic device may be a flexible electronic device. The electronic device disclosed herein is not limited to the above-listed devices, and may include new electronic devices depending on the development of technology.

Hereinafter, electronic devices are described with reference to the accompanying drawings, according to various embodiments of the present disclosure. As used herein, the term “user” may denote a human or another device (e.g., an artificial intelligent electronic device) using the electronic device.

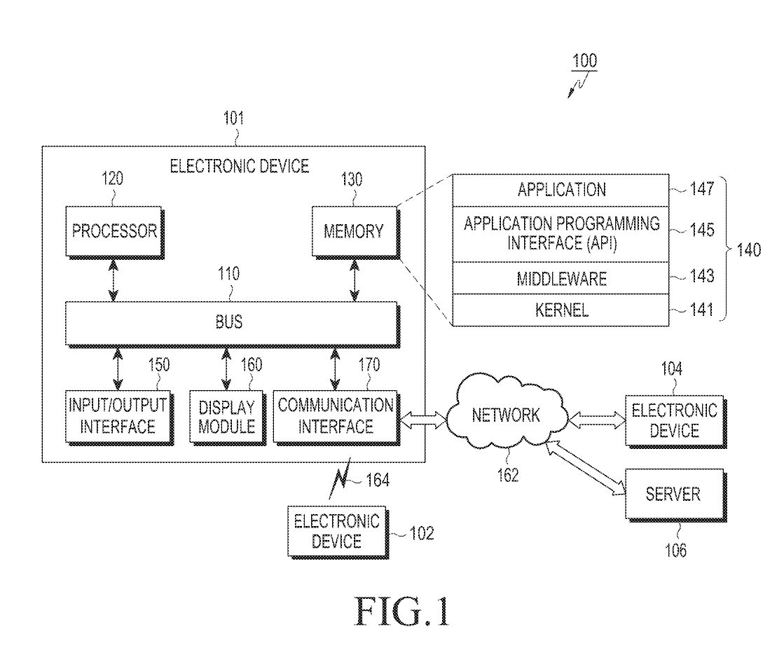

FIG. 1 illustrates an electronic device in a network environment according to an embodiment of the present disclosure.

Referring to FIG. 1, according to an embodiment of the present disclosure, an electronic device 101 is included in a network environment 100. The electronic device 101 may include a bus 110, a processor 120, a memory 130, an input/output interface 150, a display 160, and a communication interface 170. In some embodiments of the present disclosure, the electronic device 101 may exclude at least one of the components or may add another component.

The bus 110 may include a circuit for connecting the components 110 to 170 with one another and transferring communications (e.g., control messages and/or data) between the components.

The processor 120 may include one or more of a central processing unit (CPU), an application processor (AP), or a communication processor (CP). The processor 120 may perform control on at least one of the other components of the electronic device 101, and/or perform an operation or data processing relating to communication.

According to an embodiment of the present disclosure, the processor 120 may perform a process for compressing image data or restoring the compressed image data. For example, when the processor 120 includes one AP and one image processor, the AP may compress image data and provide the compressed image data to the image processor. In such case, the image processor may restore and display the compressed image data. For example, when the processor 120 includes one AP and one image processor, the AP may provide uncompressed image data to the image processor. In such case, the image processor may compress the image data provided from the AP and may restore the compressed image data for display.

The memory 130 may include a volatile and/or non-volatile memory. For example, the memory 130 may store commands or data related to at least one other component of the electronic device 101. According to an embodiment of the present disclosure, the memory 130 may store software and/or a program 140. The program 140 may include, e.g., a kernel 141, middleware 143, an application programming interface (API) 145, and/or an application program (or “application”) 147. At least a portion of the kernel 141, middleware 143, or API 145 may be denoted an operating system (OS).

For example, the kernel 141 may control or manage system resources (e.g., the bus 110, processor 120, or a memory 130) used to perform operations or functions implemented in other programs (e.g., the middleware 143, API 145, or application program 147). The kernel 141 may provide an interface that allows the middleware 143, the API 145, or the application program 147 to access the individual components of the electronic device 101 to control or manage system resources.

The middleware 143 may function as a relay to allow the API 145 or the application program 147 to communicate data with the kernel 141. A plurality of applications 147 may be provided. The middleware 143 may control (e.g., scheduling or load balancing) work requests received from the application program 147, e.g., by allocation the priority of using the system resources of the electronic device 101 (e.g., the bus 110, the processor 120, or the memory 130) to at least one application of the plurality of application programs 147.

The API 145 is an interface allowing the application 147 to control functions provided from the kernel 141 or the middleware 143. For example, the API 145 may include at least one interface or function (e.g., a command) for file control, window control, image processing or text control.

The input/output interface 150 may serve as an interface that may, e.g., transfer commands or data input from a user or other external devices to other component(s) of the electronic device 101. Further, the input/output interface 150 may output commands or data received from other component(s) of the electronic device 101 to the user or the other external device.

The display 160 may include, e.g., a liquid crystal display (LCD), a light emitting diode (LED) display, an organic light emitting diode (OLED) display, or a microelectromechanical systems (MEMS) display, or an electronic paper display. The display 160 may display, e.g., various contents (e.g., text, images, videos, icons, or symbols) to the user. The display 160 may include a touchscreen and may receive, e.g., a touch, gesture, proximity or hovering input using an electronic pen or a body portion of the user.

For example, the communication interface 170 may set up communication between the electronic device 101 and an external device (e.g., a first external electronic device 102, a second external electronic device 104, or a server 106). For example, the communication interface 170 may be connected with a network 162 or a network 164 through wireless or wired communication to communicate with the external electronic device (e.g., the second external electronic device 104 or the server 106).

The wireless communication may use at least one of, e.g., long term evolution (LTE), long term evolution advanced (LTE-A), code division multiple access (CDMA), wideband code division multiple access (WCDMA), universal mobile telecommunications system (UMTS), wireless broadband (WiBro), or global system for mobile communications (GSM), as a cellular communication protocol. The wired connection may include at least one of universal serial bus (USB), high definition multimedia interface (HDMI), recommended standard-232 (RS-232), or plain old telephone service (POTS). The network 162 may include at least one of a telecommunication network, e.g., a computer network (e.g., LAN or WAN), Internet, or a telephone network.

The first external electronic device 102 and the second external electronic device 104 each may be a device of the same or a different type from the electronic device 101. According to an embodiment of the present disclosure, the server 106 may include a group of one or more servers. According to an embodiment of the present disclosure, all or some of operations executed on the electronic device 101 may be executed on another or multiple other electronic devices (e.g., the first external electronic device 102 and the second external electronic device 104 or the server 106). According to an embodiment of the present disclosure, when the electronic device 101 should perform some function or service automatically or at a request, the electronic device 101, instead of executing the function or service on its own or additionally, may request another device (e.g., the first external electronic device 102 and the second external electronic device 104 or the server 106) to perform at least some functions associated therewith. The other electronic device (e.g., the first external electronic device 102 and the second external electronic device 104 or the server 106) may execute the requested functions or additional functions and transfer a result of the execution to the electronic device 101. The electronic device 101 may provide a requested function or service by processing the received result as it is or additionally. To that end, a cloud computing, distributed computing, or client-server computing technique may be used, for example.

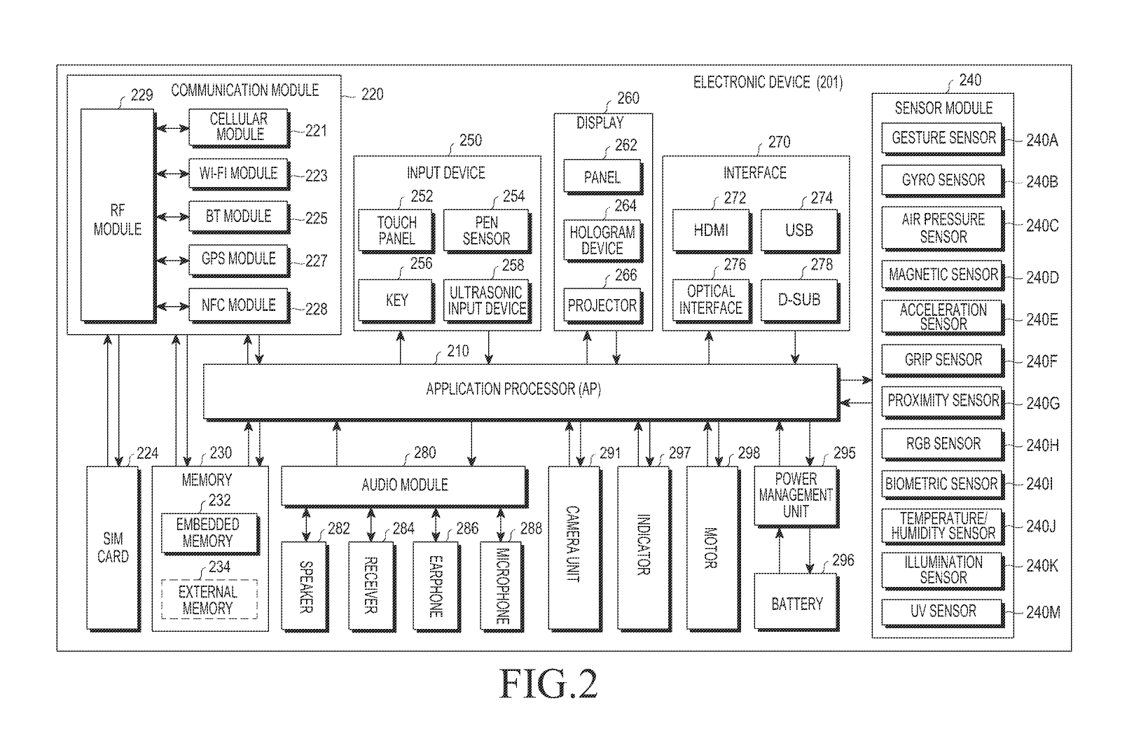

FIG. 2 is a block diagram illustrating a configuration of an electronic device according to an embodiment of the present disclosure.

Referring to FIG. 2, an electronic device 201 may include the whole or part of the configuration of, e.g., the electronic device 101 shown in FIG. 1. The electronic device 201 may include one or more application processors (APs) 210, a communication module 220, a subscriber identification module (SIM) card 224, a memory 230, a sensor module 240, an input device 250, a display 260, an interface 270, an audio module 280, a camera module 291, a power management module 295, a battery 296, an indicator 297, and a motor 298.

The AP 210 may control multiple hardware and software components connected to the AP 210 by running, e.g., an operating system or application programs, and the AP 210 may process and compute various data. The AP 210 may be implemented in, e.g., a system on chip (SoC). According to an embodiment of the present disclosure, the AP 210 may further include a graphical processing unit (GPU) and/or an image signal processor. The AP 210 may include at least some (e.g., the cellular module 221) of the components shown in FIG. 2. The AP 210 may load a command or data received from at least one of other components (e.g., a non-volatile memory) on a volatile memory, process the command or data, and store various data in the non-volatile memory.

The communication module 220 may have the same or similar configuration to the communication interface 170 of FIG. 1. The communication module 220 may include, e.g., a cellular module 221, a Wi-Fi module 223, a BT module 225, a GPS module 227, an NFC module 228, and a radio frequency (RF) module 229.

The cellular module 221 may provide voice call, video call, text, or Internet services through, e.g., a communication network. According to an embodiment of the present disclosure, the cellular module 221 may perform identification or authentication on the electronic device 201 in the communication network using a SIM (e.g., the SIM card 224). According to an embodiment of the present disclosure, the cellular module 221 may perform at least some of the functions provided by the AP 210. According to an embodiment of the present disclosure, the cellular module 221 may include a CP.

The Wi-Fi module 223, the BT module 225, the GPS module 227, or the NFC module 228 may include a process for, e.g., processing data communicated through the module. According to an embodiment of the present disclosure, at least some (e.g., two or more) of the cellular module 221, the Wi-Fi module 223, the BT module 225, the GPS module 227, or the NFC module 228 may be included in a single integrated circuit (IC) or an IC package.

The RF module 229 may communicate, e.g., communication signals (e.g., RF signals). The RF module 229 may include, e.g., a transceiver, a power amp module (PAM), a frequency filter, a low noise amplifier (LNA), or an antenna. According to an embodiment of the present disclosure, at least one of the cellular module 221, the Wi-Fi module 223, the BT module 225, the GPS module 227, or the NFC module 228 may communicate RF signals through a separate RF module.

The SIM card 224 may include, e.g., a card including a SIM and/or an embedded SIM, and may contain unique identification information (e.g., an IC card identifier (ICCID) or subscriber information (e.g., an international mobile subscriber identity (IMSI)).

The memory 230 (e.g., the memory 230) may include, e.g., an internal memory 232 or an external memory 234. The internal memory 232 may include at least one of, e.g., a volatile memory (e.g., a dynamic RAM (DRAM), a static RAM (SRAM), a synchronous dynamic RAM (SDRAM), and the like) or a non-volatile memory (e.g., a one time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash, or a NOR flash), a hard drive, or solid state drive (SSD).

The external memory 234 may include a flash drive, e.g., a compact flash (CF) memory, a secure digital (SD) memory, a micro-SD memory, a min-SD memory, an extreme digital (xD) memory, or a memory stick™. The external memory 234 may be functionally and/or physically connected with the electronic device 201 via various interfaces.

The sensor module 240 may measure a physical quantity or detect an operational stage of the electronic device 201, and the sensor module 240 may convert the measured or detected information into an electrical signal. The sensor module 240 may include at least one of, e.g., a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H, such as an RGB (Red, Green, Blue) sensor, a bio sensor 240I, a temperature/humidity sensor 240J, an illumination sensor 240K, or an ultra violet (UV) sensor 240M. Additionally or alternatively, the sensor module 240 may include, e.g., an E-nose sensor, an electromyography (EMG) sensor, an electroencephalogram (EEG) sensor, an electrocardiogram (ECG) sensor, an infrared (IR) sensor, an iris sensor, or a finger print sensor. The sensor module 240 may further include a control circuit for controlling at least one or more of the sensors included in the sensor module 240. According to an embodiment of the present disclosure, the electronic device 201 may further include a processor configured to control the sensor module 240 as part of an AP 210 or separately from the AP 210, and the electronic device 201 may control the sensor module 240 while the AP is in a sleep mode.

The input unit 250 may include a touch panel 252, a (digital) pen sensor 254, a key 256, or an ultrasonic input device 258. The touch panel 252 may use at least one of capacitive, resistive, infrared, or ultrasonic methods. The touch panel 252 may further include a control circuit. The touch panel 252 may further include a tactile layer and may provide a user with a tactile reaction.

The (digital) pen sensor 254 may include, e.g., a part of a touch panel or a separate sheet for recognition. The key 256 may include e.g., a physical button, optical key or key pad. The ultrasonic input device 258 may use an input tool that generates an ultrasonic signal and enable the electronic device 201 to detect data by detecting the ultrasonic signal to a microphone (e.g., the microphone 288).

The display 260 (e.g., the display 160) may include a panel 262, a hologram device 264, or a projector 266. The panel 262 may have the same or similar configuration to the display 160 of FIG. 1. The panel 262 may be implemented to be flexible, transparent, or wearable. The panel 262 may also be incorporated with the touch panel 252 in a unit. The hologram device 264 may make three dimensional (3D) images (holograms) in the air by using light interference. The projector 266 may display an image by projecting light onto a screen. The screen may be, for example, located inside or outside of the electronic device 201. In accordance with an embodiment of the present disclosure, the display 260 may further include a control circuit to control the panel 262, the hologram device 264, or the projector 266.

The interface 270 may include e.g., an HDMI 272, a USB 274, an optical interface 276, or a D-subminiature (D-sub) 278. The interface 270 may be included in e.g., the communication interface 170 shown in FIG. 1. Additionally or alternatively, the interface 270 may include a mobile high-definition link (MHL) interface, a SD card/multimedia card (MMC) interface, or IrDA standard interface.

The audio module 280 may convert a sound into an electric signal or vice versa, for example. At least a part of the audio module 280 may be included in e.g., the input/output interface 150 referring to FIG. 1. The audio module 280 may process sound information input or output through e.g., a speaker 282, a receiver 284, an earphone 286, or a microphone 288.

For example, the camera module 291 may be a device for capturing still images and videos, and may include, according to an embodiment of the present disclosure, one or more image sensors (e.g., front and back sensors), a lens, an Image Signal Processor (ISP), or a flash, such as an LED or xenon lamp.

The power manager module 295 may manage power of the electronic device 201. Although not shown, according to an embodiment of the present disclosure, a power management integrated circuit (PMIC), a charger IC, or a battery or fuel gauge is included in the power manager module 295. The PMIC may have a wired and/or wireless recharging scheme. The wireless charging scheme may include e.g., a magnetic resonance scheme, a magnetic induction scheme, or an electromagnetic wave based scheme, and an additional circuit, such as a coil loop, a resonance circuit, a rectifier, or the like may be added for wireless charging. The battery gauge may measure an amount of remaining power of the battery 296, a voltage, a current, or a temperature while the battery 296 is being charged. The battery 296 may include, e.g., a rechargeable battery or a solar battery.

The indicator 297 may indicate a particular state of the electronic device 201 or a part of the electronic device (e.g., the AP 210), the particular state including e.g., a booting state, a message state, or charging state. The motor 298 may convert an electric signal to a mechanical vibration and may generate a vibrational or haptic effect. Although not shown, a processing unit for supporting mobile TV, such as a GPU may be included in the electronic device 201. The processing unit for supporting mobile TV may process media data conforming to a standard for digital multimedia broadcasting (DMB), digital video broadcasting (DVB), or media flow.

Each of the aforementioned components of the electronic device may include one or more parts, and a name of the part may vary with a type of the electronic device. The electronic device in accordance with various embodiments of the present disclosure may include at least one of the aforementioned components, omit some of them, or include other additional component(s). Some of the components may be combined into an entity, but the entity may perform the same functions as the components.

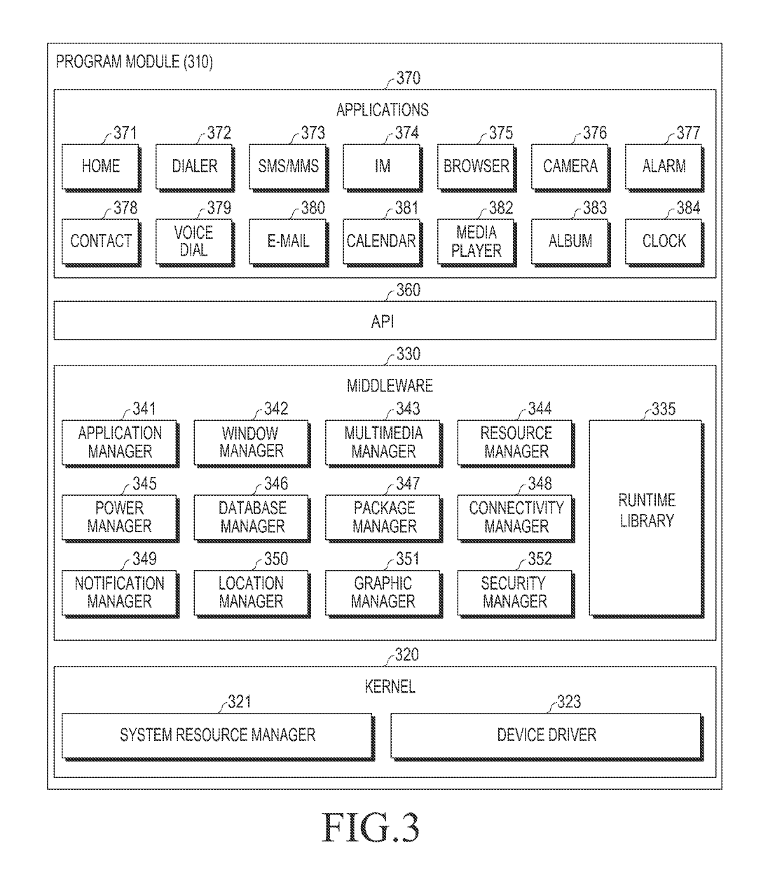

FIG. 3 is a block diagram illustrating a configuration of a program module according to an embodiment of the present disclosure.

Referring to FIG. 3, according to an embodiment of the present disclosure, a program module 310 (e.g., the program 140) may include an operating system (OS) controlling resources related to the electronic device (e.g., the electronic device 101) and/or various applications (e.g., the application processor 147) driven on the operating system. The operating system may include, e.g., Android, iOS, Windows, Symbian, Tizen, or Bada.

The program 310 may include, e.g., a kernel 320, middleware 330, an application programming interface (API) 360, and/or an application 370. At least a part of the program module 310 may be preloaded on the electronic device or may be downloaded from a server (e.g., the server 106).

The kernel 320 (e.g., the kernel 141 of FIG. 1) may include, e.g., a system resource manager 321 or a device driver 323. The system resource manager 321 may perform control, allocation, or recovery of system resources. According to an embodiment of the present disclosure, the system resource manager 321 may include a process managing unit, a memory managing unit, or a file system managing unit. The device driver 323 may include, e.g., a display driver, a camera driver, a Bluetooth driver, a shared memory driver, a USB driver, a keypad driver, a Wi-Fi driver, an audio driver, or an inter-process communication (IPC) driver.

The middleware 330 may provide various functions to the application 370 through the API 360 so that the application 370 may efficiently use limited system resources in the electronic device or provide functions jointly required by applications 370. According to an embodiment of the present disclosure, the middleware 330 (e.g., middleware 143) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, or a security manager 352.

The runtime library 335 may include a library module used by a compiler in order to add a new function through a programming language while, e.g., the application 370 is being executed. The runtime library 335 may perform input/output management, memory management, or operation on arithmetic functions.

The application manager 341 may manage the life cycle of at least one application of, e.g., the applications 370. The window manager 342 may manage GUI resources used on the screen. The multimedia manager 343 may grasp formats necessary to play various media files and use a codec appropriate for a format to perform encoding or decoding on media files. The resource manager 344 may manage resources, such as source code of at least one of the applications 370, memory or storage space.

The power manager 345 may operate together with, e.g., a basic input/output system (BIOS) to manage battery or power and provide power information necessary for operating the electronic device. The database manager 346 may generate, search, or vary a database to be used in at least one of the applications 370. The package manager 347 may manage installation or update of an application that is distributed in the form of a package file.

The connectivity manager 348 may manage wireless connectivity, such as, e.g., Wi-Fi or Bluetooth. The notification manager 349 may display or notify an event, such as a coming message, an appointment, or a proximity notification, of the user without interfering with the user. The location manager 350 may manage locational information on the electronic device. The graphic manager 351 may manage graphic effects to be offered to the user and their related user interface. The security manager 352 may provide various security functions necessary for system security or user authentication. According to an embodiment of the present disclosure, when the electronic device (e.g., the electronic device 101) has telephony capability, the middleware 330 may further include a telephony manager for managing voice call or video call functions of the electronic device.

The middleware 330 may include a middleware module forming a combination of various functions of the above-described components. The middleware 330 may provide a specified module per type of the operating system in order to provide a differentiated function. Further, the middleware 330 may dynamically omit some existing components or add new components.

The API 360 (e.g., the API 145) may be a set of, e.g., API programming functions and may have different configurations depending on operating systems. For example, in the case of Android or iOS, one API set may be provided per platform, and in the case of Tizen, two or more API sets may be offered per platform.

The application 370 (e.g., the application processor 147) may include one or more applications that may provide functions such as, e.g., a home 371, a dialer 372, an SMS/MMS 373, an instant message (IM) 374, a browser 375, a camera 376, an alarm 377, a contact 378, a voice dial 379, an email 380, a calendar 381, a media player 382, an album 383, or a clock 384, a health-care (e.g., measuring the degree of workout or blood sugar), or provision of environmental information (e.g., provision of air pressure, moisture, or temperature information).

According to an embodiment of the present disclosure, the application 370 may include an application (hereinafter, “information exchanging application” for convenience) supporting information exchange between the electronic device (e.g., the electronic device 101) and an external electronic device (e.g., the first external electronic device 102 and the second external electronic device 104). Examples of the information exchange application may include, but is not limited to, a notification relay application for transferring specific information to the external electronic device, or a device management application for managing the external electronic device.

For example, the notification relay application may include a function for relaying notification information generated from other applications of the electronic device (e.g., the SMS/MMS application, email application, health-care application, or environmental information application) to the external electronic device (e.g., the first external electronic device 102 and the second external electronic device 104). Further, the notification relay application may receive notification information from, e.g., the external electronic device and may provide the received notification information to the user. The device management application may perform at least some functions of the external electronic device (e.g., the second external electronic device 104) communicating with the electronic device (for example, turning on/off the external electronic device (or some components of the external electronic device) or control of brightness (or resolution) of the display), and the device management application may manage (e.g., install, delete, or update) an application operating in the external electronic device or a service (e.g., call service or message service) provided from the external electronic device.

According to an embodiment of the present disclosure, the application 370 may include an application (e.g., a health-care application) designated depending on the attribute (e.g., as an attribute of the electronic device, the type of electronic device is a mobile medical device) of the external electronic device (e.g., the first external electronic device 102 and the second external electronic device 104). According to an embodiment of the present disclosure, the application 370 may include an application received from the external electronic device (e.g., the server 106 or the first external electronic device 102 and the second external electronic device 104). According to an embodiment of the present disclosure, the application 370 may include a preloaded application or a third party application downloadable from a server. The names of the components of the program module 310 according to the shown embodiment may be varied depending on the type of operating system.

According to an embodiment of the present disclosure, at least a part of the program module 310 may be implemented in software, firmware, hardware, or in a combination of two or more thereof. At least a part of the programming module 310 may be implemented (e.g., executed) by e.g., a processor (e.g., the AP 210). At least a part of the programming module 310 may include e.g., a module, program, routine, set of instructions, process, or the like for performing one or more functions.

The term ‘module’ may refer to a unit including one of hardware, software, and firmware, or a combination thereof. The term ‘module’ may be interchangeably used with a unit, logic, logical block, component, or circuit. The module may be a minimum unit or part of an integrated component. The ‘module’ may be a minimum unit or part of performing one or more functions. The module may be implemented mechanically or electronically. For example, the module may include at least one of application specific integrated circuit (ASIC) chips, field programmable gate arrays (FPGAs), or programmable logic arrays (PLAs) that perform some operations, which have already been known or will be developed in the future.

According to an embodiment of the present disclosure, at least a part of the device (e.g., modules or their functions) or method (e.g., operations) may be implemented as instructions stored in a non-transitory computer-readable storage medium e.g., in the form of a program module. The instructions, when executed by a processor (e.g., the processor 120), may enable the processor to carry out a corresponding function. The non-transitory computer-readable storage medium may be e.g., the memory 130.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a Read-Only Memory (ROM), a Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

Modules or programming modules in accordance with various embodiments of the present disclosure may include at least one or more of the aforementioned components, omit some of them, or further include other additional components. Operations performed by modules, programming modules or other components in accordance with various embodiments of the present disclosure may be carried out sequentially, simultaneously, repeatedly, or heuristically. Furthermore, some of the operations may be performed in a different order, or omitted, or include other additional operation(s).

The embodiments disclosed herein are proposed for description and understanding of the disclosed technology and does not limit the scope of the present disclosure. Accordingly, the scope of the present disclosure should be interpreted as including all changes or various embodiments based on the technical spirit of the present disclosure.

According to an embodiment of the present disclosure, there is proposed an image processing scheme for compressing an image frame that does not cause a visual image loss. To that end, an encoder may split an image frame into data blocks with a certain size and may obtain a compression mode whose minimum error rate is predicted from among multiple compression modes previously configured per data block.

According to an embodiment of the present disclosure, the encoder may compute an error rate for each of the multiple previously configured compression modes to find a minimum error rate. For example, the encoder may perform encoding on one data block using one compression mode among the multiple previously configured compression modes and reconfigure a data block based on a compressed bitstream generated by the encoding. The error rate for the compression mode may be computed based on a data block before the compression and a reconfigured data block.

According to an embodiment of the present disclosure, the error rates of the multiple previously configured compression modes may be computed by the same procedure. The error rates of all the compression modes may be computed by the same procedure including encoding a data block based on a corresponding compression mode, reconfiguring the data block by a compressed bitstream according to the encoding, and obtaining an error rate by the original data block and the reconfigured data block.

According to an embodiment of the present disclosure, the encoder, when obtaining a compression mode in which a minimum error rate is predicted to be obtained, may finally output a compressed bitstream according to the obtained compression mode. Different fields may be defined in the compressed bitstream per compression mode. However, some of the fields constituting the compressed bitstream may be commonly required for all of the compression modes. For example, information for identifying a compression mode used to obtain the minimum error rate, i.e., mode selection information, may be commonly included in compression bit streams generated by all the compression modes.

According to an embodiment of the present disclosure, the encoder may manage a prediction table as latest information in order to perform encoding by multiple previously configured compression modes. For example, the encoder may compute an error rate corresponding to each compression mode and reflect its result to the prediction table. The encoder may update information in the prediction table using information obtained while computing the error rate. The prediction table may include one representative value (RV) table.

Hereinafter, various embodiments of the present disclosure are described with reference to the accompanying drawings.

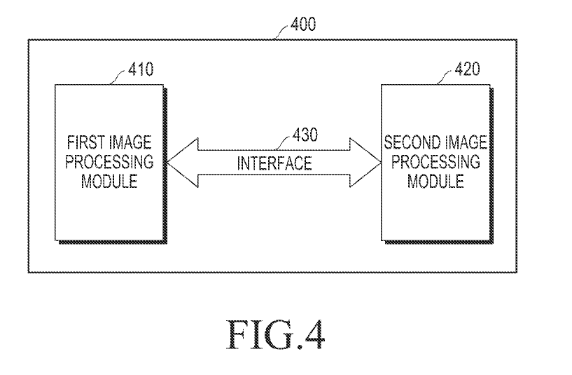

FIG. 4 illustrates a configuration of an image processing device according to an embodiment of the present disclosure.

Referring to FIG. 4, an image processing device 400 (e.g., the electronic device 100) may display an image through image processing. According to an embodiment of the present disclosure, the image processing device 400 may perform image processing, such as image compression and restoration. According to an embodiment of the present disclosure, the image processing device 400 may compress an image frame corresponding to a still image or a motion image or may restore a compressed image frame.

The image processing device 400 may record a compressed image frame in a designated recording medium or may transmit the compressed image frame to an external device through a certain communication network. According to an embodiment of the present disclosure, the image processing device may restore a compressed image frame recorded in the recording medium or may restore a compressed image frame transmitted from the external device through the certain communication network.

According to an embodiment of the present disclosure, it is assumed that the image processing device 400 internally compresses or restores an image frame. According to an embodiment of the present disclosure, the image processing device 400 may include two image processing modules 410 and 420 and an interface 430 connecting the two image processing modules 410 and 420.

According to an embodiment of the present disclosure, the second image processing module 420 may receive an image frame from the first image processing module 410 through the interface 430. The image frame provided from the first image processing module 410 to the second image processing module 420 may be compressed or uncompressed.

According to an embodiment of the present disclosure, when the first image processing module 410 includes an encoder, the first image processing module 410 may provide a compressed image frame to the second image processing module 420. In such case, the second image processing module 420 might not include a separate encoder.

According to an embodiment of the present disclosure, when the first image processing module 410 does not include an encoder, the first image processing module 410 may provide an uncompressed image frame to the second image processing module 420. In such case, the second image processing module 420 may include an encoder for compressing the received image frame.

For example, when the first image processing module 410 provides compressed image data to the second image processing module 420, the first image processing module 410 may compress the image data by an internal encoder and transfer the compressed image data to the second image processing module 420 through the interface 430. The second image processing module 420 may store the compressed image data transferred through the interface 430 in a frame buffer, a storage region.

According to an embodiment of the present disclosure, the second image processing module 420 may restore the compressed image data stored in the frame buffer and may output the restored image data for display. According to an embodiment of the present disclosure, the second image processing module 420 may directly restore the compressed image data and may output the restored image data for display. In this case, the second image processing module 420 might not include a frame buffer for temporarily storing the compressed image data.

According to an embodiment of the present disclosure, when the first image processing module 410 compresses and transmits image data, the second image processing module 420, although having an encoder, may determine whether to compress the image data received from the first image processing module 410 and might not use the encoder included in the second image processing module 420.

According to the above-described embodiments of the present disclosure, when compressed image data is transferred through the interface, the first image processing module 410 may reduce the bandwidth of the image data transmitted through the interface 430 used for transferring the image data and transmit the same.

For example, when the first image processing module 410 provides uncompressed image data to the second image processing module 420, the first image processing module 410 may transfer the uncompressed image data to the second image processing module 420 through the interface 430. The second image processing module 420 may compress the image data transferred through the interface 430 and may store the compressed image data in the frame buffer, a storage region.

According to an embodiment of the present disclosure, the second image processing module 420 may restore the compressed image data stored in the frame buffer and may output the restored image data for display. According to an embodiment of the present disclosure, the second image processing module 420 may directly restore the compressed image data and may output the restored image data for display. In this case, the second image processing module 420 might not include a frame buffer for temporarily storing the compressed image data.

According to an embodiment of the present disclosure, the first image processing module 410 of FIG. 4 may include an application processor (AP), and the second image processing module 420 may include a display driver chip (DDI) or a timing controller (T-CON).

For example, the first image processing module 410 in the image processing device may include an AP, and the second image processing module 420 may include a DDI.

The AP and the DDI may be parts that are in charge of processing images to be displayed on the display in the mobile device, e.g., a smartphone.

The AP may provide a compressed or uncompressed image frame to the DDI through an interface. The interface may be a high-speed serial interface that may easily transfer image data. The high-speed serial interface may include a mobile industry processor interface (MIPI), an embedded display port (eDP), and a serial peripheral interface (SPI).

As another example, the first image processing module 410 in the image processing device may include an AP, and the second image processing module 420 may include a T-CON. The AP and the T-CON may be parts or modules that are in charge of processing images to be displayed on the display in the mobile device, e.g., a tablet PC.

The AP may provide a compressed or uncompressed image frame to the T-CON through an interface. The interface may be a high-speed serial interface that may easily transfer image data. The high-speed serial interface may include, e.g., an MIPI, an eDP, and an SPI.

According to an embodiment of the present disclosure, the second image processing module 420 in the image processing device may include a plurality of T-CONs T-CON1 and T-CON-2. The plurality of T-CONs T-CON1 and T-CON2 may receive at least one of images IMG1 and IMG2 or signals (e.g., commands, main clocks, vertical sync signals, and the like) from the processor and may generate control signals for controlling source drivers SDRV1 and SDRV2 based on the received signals. According to an embodiment of the present disclosure, the plurality of T-CONs T-CON1 and T-CON2 may include an image processing unit and may process the received images IMG1 and IMG2. According to an embodiment of the present disclosure, the image processing unit may be implemented as a separate module other than the plurality of T-CONs T-CON1 and T-CON2.

As another example, the first image processing module 410 in the image processing device may include an AP, and the second image processing module 420 may include both a DDI and a T-CON.

FIG. 5 illustrates an image processing device according to an embodiment of the present disclosure.

Referring to FIG. 5, the image processing device includes a first image processing module 410, a second image processing module 420, and an interface 430 for connecting the first and second image processing modules 410 and 420. The first image processing module 410 may provide a compressed image frame or an uncompressed image frame to the second image processing module 420.

According to an embodiment of the present disclosure, the first image processing module 410 may include an encoder 514 to provide the compressed image frame to the second image processing module 420. When providing the uncompressed image frame to the second image processing module 420, the first image processing module 410 might not include the encoder 514.

According to an embodiment of the present disclosure, the second image processing module 420 that receives the compressed image frame from the first image processing module 410 might not include the encoder 523, or even when including the encoder 523, might not need the operation. However, the second image processing module 420 that receives the uncompressed image frame from the first image processing module 410 may include the encoder 523.

FIG. 5 illustrates only components necessary to process image data in the first image processing module 410 and the second image processing module 420, considering whether there is a relationship with various embodiments.

According to an embodiment of the present disclosure, the first image processing module 410 compressing and outputting image data may include a frame buffer 512, an encoder 514, and an interface 516. The second image processing module 420 restoring the compressed image data may include an interface 521, an encoder 523, a memory 525, a decoder 527, and an interface 529. The first image processing module 410 might not include the encoder 514, and the second image processing module 420 might not include the encoder 523. According to an embodiment of the present disclosure, when the first image processing module 410 includes the encoder 514, the second image processing module 420 might not include the encoder 523. However, when the first image processing module 410 does not include the encoder 514, the second image processing module 420 may include the encoder 523.

The configuration of the first image processing module 410 and the second image processing module 420 may be varied considering uses or schemes to implement.

According to an embodiment of the present disclosure, the two interfaces 521 and 529 included in the second image processing module 420 may be implemented as one interface. The memory 525 included in the second image processing module 420 may be provided in the interface 521 or decoder 527, rather than being provided as a separate component. According to an embodiment of the present disclosure, the frame buffer 512 may be replaced with a recording region provided in the interface 516 for temporarily storing the image frame to be transferred to another device.

First, an embodiment in which the first image processing module 410 provides a compressed image frame to the second image processing module 420 is described.

According to an embodiment of the present disclosure, the first image processing module 410 outputting a compressed image frame is described. The frame buffer 512 may be implemented by providing a recording region for temporarily storing an image frame to be compressed by the encoder 514.

The frame buffer 512 may record an image frame (or image data) input for compression. The number of image frames recorded in the frame buffer 512 may be adjusted by the buffer size.

When the frame buffer 512 has a size for recording one image frame, a still image or motion image recorded in the frame buffer 512 may be updated for each image frame.

The encoder 514 may encode the image frame provided from the frame buffer 512 considering a frame compression rate and compression scheme and may output an image frame compressed by the encoding.

The frame compression rate may be set to a fixed value. According to an embodiment of the present disclosure, the frame compression rate may be ¼. The frame compression rate being ¼ means that a ratio in size of the image frame before compression to the image frame after compression is 4:1.

According to an embodiment of the present disclosure, when one image frame is split in data block units (16 pixels (8×2)), the size of one data block may be 384 bits (16×3×8). Here, ‘16’ that determines the size of one data block before compression is the number of pixels constituting one data block before compression, ‘3’ three color components red, green and blue (R, G, B) constituting each pixel, and ‘8’ the number of bits representing each color component.

The compression scheme may target all encoding schemes that may be used for image compression. Considering the type or characteristics of an image frame input for compression (hereinafter, denoted a ‘target image frame’), a plurality of encoding schemes proper to encode the target image frame may be chosen and used. According to an embodiment of the present disclosure, as an encoding scheme to be used, spatial prediction (hereinafter, denoted ‘compression mode 1’), codebook indexing (hereinafter, denoted ‘compression mode 2’), 4-level vector quantization block truncation coding (VQ-BTC) with interpolation (hereinafter, denoted ‘compress mode 3’), and modified 4-level VQ-BTC (hereinafter, denoted ‘compression mode 4’) may be selected.

The encoder 514 may provide encoding on the target image frame based on compression modes respectively corresponding to the selected encoding schemes.

According to an embodiment of the present disclosure, when encoding on an image frame is supported based on compression mode 1 to compression mode 4, the operation of the encoder 514 per compression mode may be summarized as follows. In the following description, one image frame may be split into a plurality of data blocks. One data block may be constituted of 16 pixels (8×2), and each pixel may be defined with 24 (3×8) information bits. Accordingly, the information bits constituting one data block that is not encoded will be 384 bits (16×3×8). The data block may be split into sub data blocks with a certain size. For example, when one data block (384 bits) is split into four sub data blocks, the size of each of the four sub data blocks may be 96 bits.

According to an embodiment of the present disclosure, 16 pixels (8×2) constituting one data block may be split into four pixels (2×2), and the four split pixels (2×2) may be defined as a sub data block.

In the case of compression mode 1, the encoder 514 may predict each of the pixels constituting the sub data block to be compressed based on neighboring pixels positioned around the sub data block to be compressed. According to an embodiment of the present disclosure, the neighboring pixels may include pixels positioned at a left side of the sub data block to be compressed, pixels positioned at an upper side thereof, pixels positioned at a left and upper side thereof, and pixels positioned at a right and upper side thereof. The neighboring pixels may be positioned in an upper line of the sub data block to be compressed or positioned in a sub data block decoded before the sub data block to be compressed.

The encoder 514 may predict each of the pixels constituting the sub data block to be compressed by the neighboring pixels positioned in different directions. The encoder 514 may include information on a direction having a minimum error rate through prediction in compression information output by the encoding.

In the case of compression mode 2, the encoder 514 may perform encoding on each pixel using a certain number of representative values registered in the RV table. According to an embodiment of the present disclosure, the RV table may include 32 representative values selected for data blocks encoded earlier. To allow the encoder 514 to maintain the 32 representative values in the RV table at a certain size, there may be proposed an efficient mechanism for updating the RV table.

In the case of compression mode 3, the encoder 514 may encode eight pixels positioned in a lower line among the pixels included in one data block using simple 4-level VQ-BTC and may encode the eight pixels positioned in an upper line using interpolation. The encoder 514 may use, for interpolation, the information on the pixels constituting a previous line and values reconfigured from the pixels constituting the lower line.

In the case of compression mode 4, the encoder 514 selects four representative values using a modified K-means algorithm. The encoder 514 may encode the data block using the four encoded representative values using 4-level VQ-BTC.

A specific encoding operation performed by the encoder 514 for each of compression modes 1 to 4 is described below. The operations respectively corresponding to the compression modes to be described below may include enhancing image quality by compression and modifying the normal operation to fit the requirements for hardware implementations.

The encoder 514 may select one of the selected compression modes. According to an embodiment of the present disclosure, the encoder 514 may calculate an error rate per compression mode and may select a compression mode having the minimum error rate based on the calculated result. The error rate may be defined by the probability of error occurrence between the original data block before compression and the reconfigured data block. The reconfigured data block may be a data block restored using the compression information obtained by encoding.

The encoder 514 may encode an image frame using the selected compression mode and output the obtained compressed bitstream. The compressed bitstream output by the encoder 514 may be provided to the interface 430.

The interface 430 may configure a compressed image frame of a format required by an opposite device or module or device based on the compressed bitstream and may transfer the same to the opposite device or module or device. According to an embodiment of the present disclosure, the interface 430 may transfer the compressed image frame to the second image processing module.

According to an embodiment of the present disclosure, the second image processing module 420 restoring the compressed image frame is described. The interface 521 may transfer the compressed image frame provided from the first image processing module 410 to the memory 525. The interface 521 may abstain from performing a separate process on the provided compressed image frame or may perform only a minimum process on the compressed image frame. According to an embodiment of the present disclosure, the interface 521 may perform such a process as to identify whether the compressed image frame is the one transferred to the interface 521.

The memory 525 may record the compressed image frame transferred by the interface 521 in a designated position according to a recording scheme previously agreed on. The memory 525 may output compressed image frames recorded for decoding in a certain order. The second image processing module 420 might not include the memory 525. When the second image processing module 420 does not include the memory 525, the compressed image frame may be directly transferred from the interface 521 to the decoder 527.

The decoder 527 may take the compressed image frame provided from the memory 525 or the interface 521 as an input. The decoder 527 may identify the compression mode used in the input compressed image frame and may decode the input compressed image frame considering the identified compression mode. The decoder 527 may output the image frame restored by decoding. The restored image frame output by the decoder 527 may be provided to the interface 529.

The interface 529 may output the restored image frame through a designated device (e.g., a display device). The interface 529 may change the format of the restored image frame in response to a request from the device to which the restored image frame is to be provided.

According to an embodiment of the present disclosure, in which the first image processing module 410 provides an uncompressed image frame to the second image processing module 420 is described.

The first image processing module 410 compressing and outputting image data may include a frame buffer 512 and an interface 516. The configuration of the first image processing module 410 may be varied considering uses or schemes to implement.

According to an embodiment of the present disclosure, the first image processing module 410 outputting an uncompressed image frame is described. The frame buffer 512 may record an input image frame (or image data). The number of image frames recorded in the frame buffer 512 may be adjusted by the buffer size. When the frame buffer 512 has a size for recording one image frame, a still image or motion image recorded in the frame buffer 512 may be updated for each image frame.

The interface 516 may provide the image frame recorded in the frame buffer 512 to the second image processing module 420. According to an embodiment of the present disclosure, the interface 516 may configure the image frame in the format required by the opposite device or module or device.

According to an embodiment of the present disclosure, the second image processing module 420 restoring the compressed image frame is described. The interface 521 may transfer the uncompressed image frame provided from the first image processing module 410 to the encoder 523. The interface 521 may abstain from performing a separate process on the provided uncompressed image frame or may perform only a minimum process on the compressed image frame. According to an embodiment of the present disclosure, the interface 521 may perform such a process as to identify whether the uncompressed image frame is the one transferred to the interface 521.

The encoder 523 may encode the image frame provided from the interface 521 considering a frame compression rate or compression scheme. The encoder 523 may output the image frame compressed by the encoding in the memory 525.

The encoding on the image frame by the encoder 523 may be performed by the same operation as the encoding by the encoder 514 included in the first image processing module 410. The compressed bitstream corresponding to the compressed image frame output by the encoder 514 may be provided to the memory 525.

The memory 525 may record the compressed image frame provided by the encoder 523 in a designated position according to a recording scheme previously agreed on. The memory 525 may output compressed image frames recorded for decoding to the decoder 527 in a certain order.

The decoder 527 may take the compressed image frame provided from the memory 525 as an input. The decoder 527 may identify the compression mode used in the compressed image frame and may decode the input compressed image frame considering the identified compression mode. The decoder 527 may output the image frame restored by decoding. The restored image frame output by the decoder 527 may be provided to the interface 529.

The interface 529 may output the restored image frame through a designated device (e.g., a display device). The interface 529 may change the format of the restored image frame in response to a request from the device to which the restored image frame is to be provided.

In the description of the structure and operation of the encoder proposed below, a fixed compression rate of 4:1 (original size: compressed size) is taken into account. However, the structure and operation of the encoded proposed are not limited to the fixed compression rate. The same or similar method may also apply to other various compression rates.

It may be assumed that, for encoding, a target image frame corresponding to one image may be split into non-overlapping blocks with a certain size. For example, the data block with the certain size may include 16 (8×2) pixels.

According to an embodiment of the present disclosure, each data block including 16 pixels may be reconfigured by encoding and decoding using a certain number of different compression algorithms (encoding schemes) that are denoted compression modes. For example, each data block may be encoded by four different compression algorithms. Each data block encoded by the different compression algorithms may be reconfigured into the data block before compression through decoding.

According to an embodiment of the present disclosure, each of the 16 pixels constituting one data block may include three color components R, G, B. The three color components R, G, B each may be represented as eight-bit information. As such, since one pixel includes three color components R, G, B each having eight bits, the pixel is supposed to be defined by 24 (=8×3)) bits of information. One data block including 16 pixels may be defined by 384 (=24×16)) of information.

For example, in order to compress each of the data blocks constituting the target image frame in a compression rate of 4:1, the encoder may represent 384-bit information with 96-bit information. According to an embodiment of the present disclosure, the four compression algorithms are described. However, various embodiments are not limited only to the four compression algorithms, and other compression algorithms may also apply in the same or similar manner.

According to an embodiment of the present disclosure, compression mode 1 may use, e.g., a spatial prediction algorithm. Compression mode 2 may use, e.g., a codebook indexing algorithm. Compression mode 3 may use, e.g., a 4-level VQ-BTC with interpolation algorithm. Compression mode 4 may use, e.g., a modified 4-level VQ-BTC algorithm.

According to an embodiment of the present disclosure, the compression algorithms may be applied to their respective compression modes for various implementations in order for minimized image quality loss and easier hardware implementation.

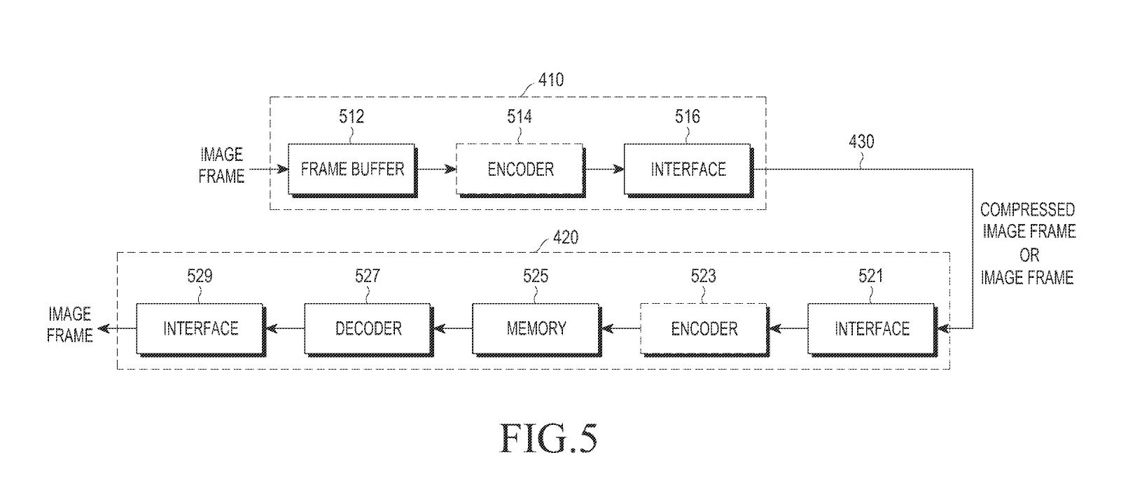

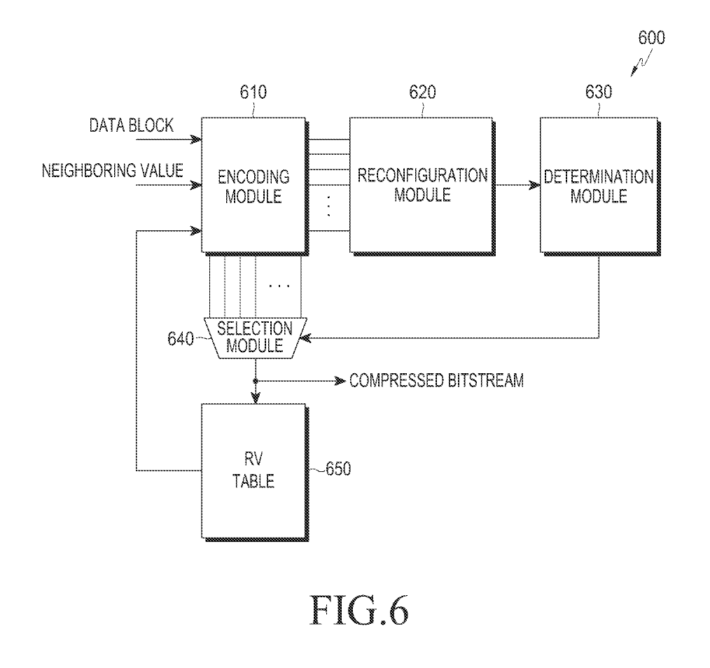

FIG. 6 illustrates a configuration of an encoder according to an embodiment of the present disclosure.

Referring to FIG. 6, an encoder 600 may have a structure for selectively apply compression algorithms that may reconfigure blocks using a minimum error value.

An encoding module 610 may take a data block and a RV as inputs. For example, the data block may be obtained by splitting a target image frame in 8×2 units. The encoding module 610 may encode the input data block using four different compression algorithms predetermined. In the following description, the compression algorithm may denote the four predetermined, different compression algorithms to compress the data block.

The neighboring value may include a value representing data blocks adjacent to the data block input for encoding. The value representing the adjacent data blocks may be a value representing the data block reconfigured by decoding the compressed data block obtained by encoding the data block. The neighboring value may be provided from the outside. For example, the neighboring value may be provided from a device, e.g., an external server managing the prediction table. The prediction table may include an RV table, a representative value of the neighboring pixels (surround pixel value), and some constant color value (constant value).

A reconfiguration module 620 may reconfigure the original data block using resultant values obtained by performing encoding per compression algorithm, neighboring values, and RV. The original data block is a data block input to the encoding module 610 for encoding. The reconfiguration may mean restoring the original data block by decoding based on the resultant value of encoding that is obtained through the encoding performed by each compression algorithm. Accordingly, the reconfiguration module 620 may output the data block reconfigured per compression algorithm.

A determination module 630 may calculate error values predicted upon compression of the data block by each compression algorithm based on the output from the reconfiguration module 620. The determination module 630 may calculate the error value based on a differential value between the original data block and the reconfigured data block.

The determination module 630 may output a selection signal for selecting a compression algorithm corresponding to the smallest error value among the error values calculated per compression algorithm.

A selection module 640 may output, as a compressed bitstream, one encoding resultant value among per-compression algorithm encoding resultant values input from the encoding module 610 using the selection signal provided by the determination module 630. The compressed bitstream may correspond to a result of the encoding on the data block input to the encoding module 610 for compression.

An RV table 650 may update the existing, stored representative value (RV) with the compressed bitstream provided by the selection module 640. The RV table 650 may provide the representative value (RV) required by the encoding module 610 for encoding the data block. The RV table 650 may configure a prediction table together with a representative value (surround pixel value) of the neighboring pixels and a certain constant color value (constant value). FIG. 9 illustrates an example of the prediction table that is described below.

The per-compression algorithm encoding resultant values output by the encoding module 610 are input to the reconfiguration module 620 and the selection module 640. The per-compression algorithm encoding resultant values may be obtained by performing encoding on the data block by each of the four compression algorithms.

The selection signal output by the determination module 630 is provided to the selection module 640. The selection signal may enable output of an encoding resultant value by the compression algorithm predicted to produce the minimum error value. The compressed bitstream output by the selection module 640 is also provided to the RV table 650.

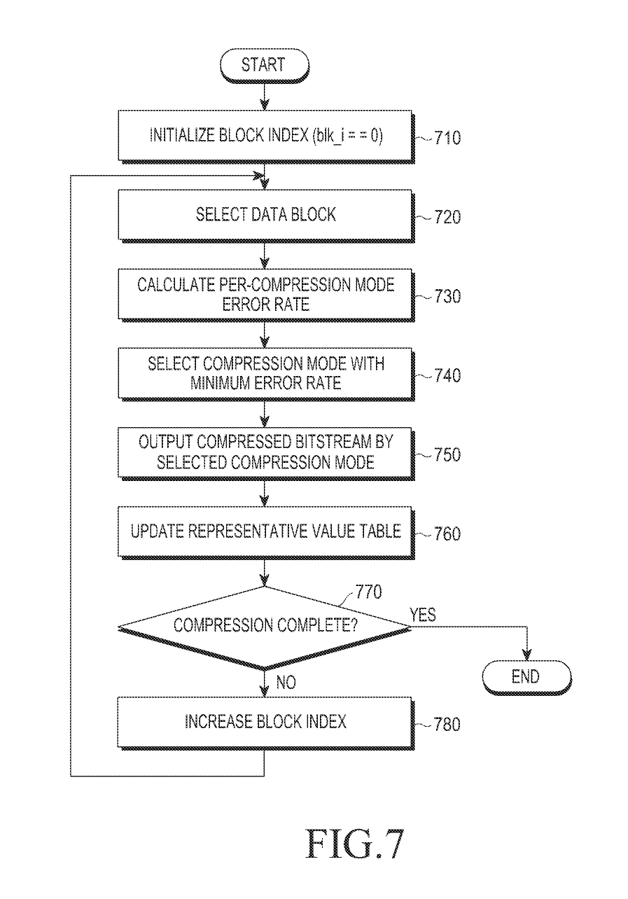

FIG. 7 is a flowchart illustrating a flow of control performed by an image compressing device according to an embodiment of the present disclosure.

Referring to FIG. 7, in operation 710, an encoder 600 may initialize a block index (blk_i). The block index (blk_i) may be used to select a data block to be compressed. According to an embodiment of the present disclosure, when one image frame is split into K data blocks with a certain size, the block index (blk_i) may be sequentially selected within a range (0≦blkᵢ≦K—1) from 0 to K-1. In initializing the block index (blk_i), a first data block among the K data blocks, e.g., the data block with a block index (blk_i) of 0, may be selected as the data block to be compressed.

In operation 720, the encoder 600 may select a data block corresponding to the block index (blk_i) from among the K data blocks obtained by splitting the target image frame. According to an embodiment of the present disclosure, when the K data blocks obtained by splitting the target image frame are sequentially input, the encoder 600 may select the data block with the current block index (blk_i) from among the input data blocks. According to an embodiment of the present disclosure, when the K data blocks obtained by splitting the target image frame are previously stored, the encoder 600 may read out the data block with the current block index (blk_i) from among the stored data blocks.

As set forth above, in order for the encoder 600 to select the data block, an operation for splitting the target image frame into K data blocks may come earlier. Further, to perform encoding as described below, an operation for splitting each data block into sub data blocks with a certain size may come earlier.

In operation 730, the encoder 600 may calculate an error rate for each of a plurality of compression modes. According to an embodiment of the present disclosure, the error rate for each of the plurality of compression modes may be calculated by block encoding on the data block, reconfiguration, and order of calculation of error rate. For example, the encoder 600 may generate a per-compression algorithm compressed bitstream by performing block encoding on the data block based on each compression mode. The encoder 600 may reconfigure the data block before compression using the compressed bitstream generated per compression mode. Accordingly, the encoder 600 may generate the data block reconfigured per compression mode. The encoder 600 may calculate a per-compression mode error rate using the data block before compression and the data block reconfigured per compression mode.

According to an embodiment of the present disclosure, the encoder 600 may calculate error rates respectively corresponding to compression modes 1 to 4 defined above. To that end, the encoder 600 may encode the data block based on each of compression modes 1 to 4 in the same or similar manner to what has been described above.

According to an embodiment of the present disclosure, the encoder 600 may reconfigure the data block before compression using each of the four compressed bitstreams obtained by encoding the data block in each of compression modes 1 to 4. The encoder 600 may calculate an error rate corresponding to the degree at which each of the four reconfigured data blocks is identical to the data block before compression.

In operation 740, the encoder 600 may select the lowest error rate from among the error rates respectively calculated for the compression modes and may identify the compression mode in which the selected error rate has been calculated.

In operation 750, the encoder 600 may output, as a result of the encoding, the compressed bitstream that is generated or has been generated by encoding the data block based on the identified compression mode.

In operation 760, the encoder 600 may update the existing representative value registered in the RV table based on the output compressed bitstream. According to an embodiment of the present disclosure, the encoder 600 may update the representative value recorded in the RV table corresponding to the data block previously selected, based on the output compressed bitstream. In this case, the encoder 600 may then use the updated representative value recorded in the RV table when encoding the data block based on each compression mode.

In operation 770, the encoder 600 may determine whether compression on the K data blocks obtained by splitting the target image frame has been complete. For example, the encoder 600 may determine whether the compression on the target image frame has been complete by determining whether the current data block index (blk_i) is K-1.

The encoder 600, upon determining that the compression on the target image frame is not complete, increases the current data block index (blk_i) by one in operation 780. Increasing the current data block index (blk_i) by one is for selecting a next data block for encoding. The encoder 600, when the next data block is selected, may perform an encoding operation on the selected data block in operations 720 to 760.

The encoder 600, upon determining that the compression on the target image frame is complete, may terminate the encoding operation on the target image frame. However, the termination of the encoding operation is merely for one image frame. When there are remaining image frames to be encoded, the operations of the control flow shown in FIG. 7 may be repeated.

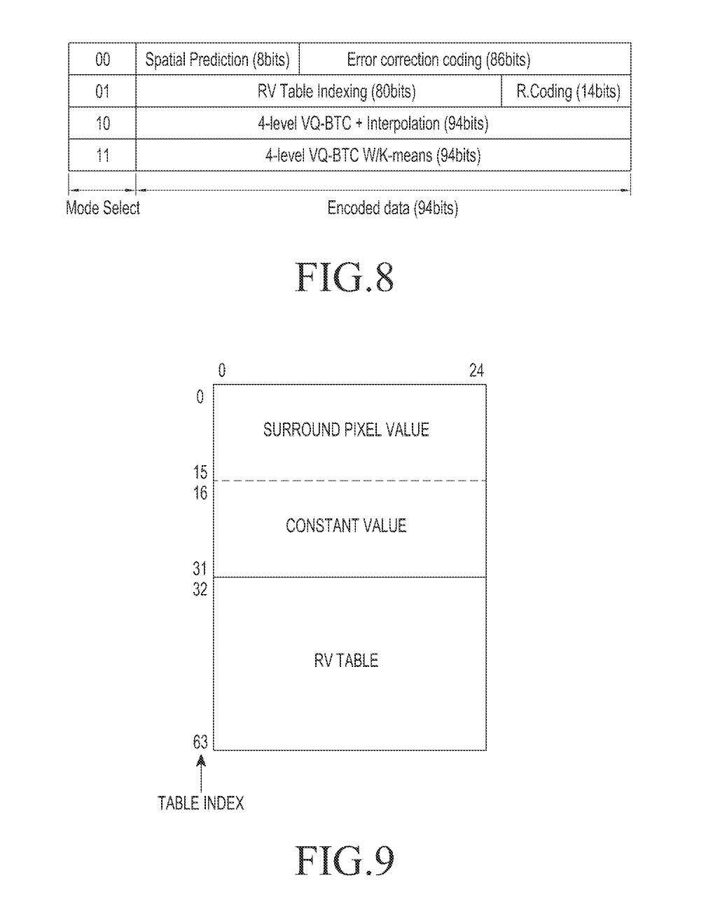

FIG. 8 illustrates a compressed bitstream output per compression mode by an encoder according to an embodiment of the present disclosure.

Referring to FIG. 8, the compressed bitstream output from the encoder has a length of 96 bits. The length of the compressed bitstream is commonly applied to all the compression modes. The compressed bitstream includes two bits of mode selection information (Mode select) and 94 bits of compressed data (Encoded data).

According to an embodiment of the present disclosure, the mode selection information ‘00’ may indicate compression mode 1 (spatial prediction), ‘01’ compression mode 2 (codebook indexing), ‘10’ compression mode 3 (4-level VQ-BTC), and ‘11’ compression mode 4 (modified 4-level VQ-BTC).

The compressed data may contain different information per compression mode. For example, the respective compressed data of compression modes 1 to 4 may include different types of data.

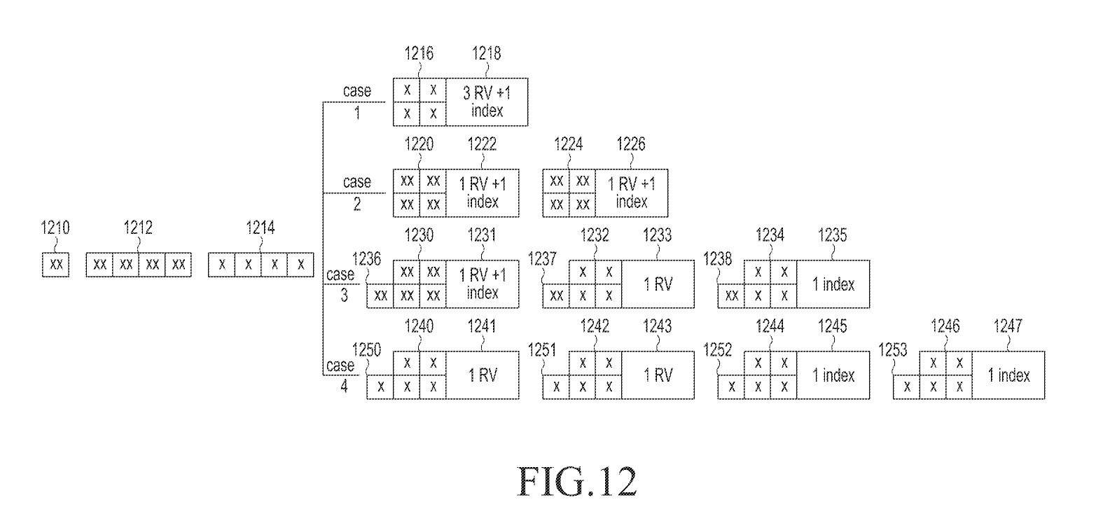

According to an embodiment of the present disclosure, the data compressed by compression mode 1 may include eight bits of spatial prediction information (Spatial Prediction), four bits of error sub data block selection information, and 82 bits or less of error correction encoding information (Error correction coding) (see FIG. 12). Different definitions may be made to the error correction encoding information depending on the number of sub data blocks with errors in one data block. This is further described below.

According to an embodiment of the present disclosure, the data compressed by compression mode 2 may include 80 bits of RV table indexing information (RV Table Indexing) and 14 bits of error correction information (R.Coding) (see FIG. 16). The error correction information may include a four-bit base index indicating a reference pixel for reconfiguring the data block, five-bit direction information (direction) for defining a vector for obtaining a target pixel from the base pixel and five-bit length information (length).

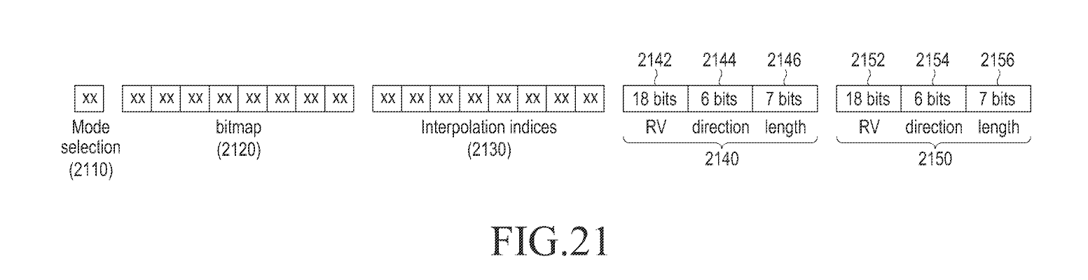

According to an embodiment of the present disclosure, the data compressed by compression mode 3 may include 94-bit 4-level VQ-BTC and interpolation information (see FIG. 21). The 4-level VQ-BTC and interpolation information may include a 16-bit bitmap for identifying the group to which each of the eight lower pixels constituting one data block belongs, 16-bit interpolation indexes for guiding a higher pixel value to be reconfigured through interpolation, and error correction information that does not exceed 62 bits obtained per group. The error correction information may include a 18-bit representative value indicating the mean value of two pixels included in each group, 6-bit direction information (direction) for defining a vector for obtaining a pixel in the group from the representative value, and 7-bit length information (length).

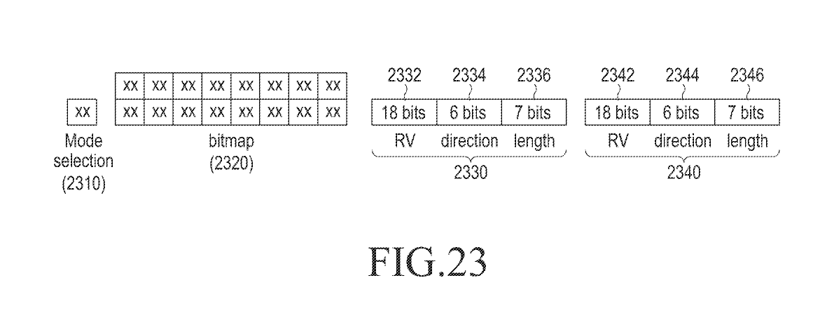

According to an embodiment of the present disclosure, the data compressed by compression mode 4 may include 94-bit 4-level VQ-BTC and interpolation information (see FIG. 23). The 4-level VQ-BTC information may include a bitmap of 16 bits for identifying the group where each of eight upper pixels and eight lower pixels constituting one data block belongs and error correction information that does not exceed 62 bits obtained per group. The error correction information may include a 18-bit representative value indicating the mean value of two pixels included in each group, 6-bit direction information (direction) for defining a vector for obtaining a pixel in the group from the representative value, and 7-bit length information (length).

The image processing device according to an embodiment of the present disclosure as proposed above presumes that the optimal compression mode to be used for encoding an image frame is selected from multiple compression modes.

Now described is an encoding operation for each of multiple compression modes to apply for encoding an image frame in an image processing device.

According to an embodiment of the present disclosure, in describing the encoding operation per compression mode, one image frame may be split into 16 data blocks. Each data block may be represented by three color components, and each color component may be represented as an eight-bit value. For example, since one image frame has a size of 384 bits (16×3×8), a 96-bit compressed bitstream may be generated upon encoding in a compression rate of 4:1. As defined earlier, the 96-bit compressed bitstream may include, e.g., 2-bit mode selection information and, e.g., 94-bit compressed data.

Configuring 94-bit compressed data per compression mode is described below.

First described is configuring compressed data using compression mode 1 that is one of various compression schemes.

The encoding operation by compression mode 1 (spatial prediction) may include determining a prediction direction as per spatial prediction, generating information for error correction, and calculating an error rate mean absolute error (MAE) by the reconfiguration of data block.

According to an embodiment of the present disclosure, the encoder may determine a prediction direction that enables the optimal spatial prediction for each sub data block obtained by splitting one data block and configure eight-bit spatial prediction information by the determined prediction direction. The encoder may configure error correction encoding information not to exceed 86 bits based on a certain scenario corresponding to the number of sub data blocks identified through spatial prediction. In this case, the encoder may configure compressed data by the eight-bit spatial prediction information and the error correction encoding information that does not exceed 86 bits and add two-bit mode selection information to the compressed data to thereby configure the compressed bitstream not to exceed 96 bits.

According to an embodiment of the present disclosure, the encoder may reconfigure the data block using the configured compressed bitstream and may calculate the error rate of the reconfigured data block. The calculated error rate may be used as at least one reference to determine a compression mode for encoding the data block.

According to an embodiment of the present disclosure, a 96-bit compressed bitstream may be generated from a 386-bit image frame using a compression rate of 4:1. The 96-bit compressed bitstream may be configured by two-bit mode selection information, eight-bit spatial prediction information, four-bit error sub data block selection information, and error correction encoding information that does not exceed 82 bits. The error correction encoding information may be smaller than 82 bits, but in such case, as many padding bits as the insufficient number may be added.

According to an embodiment of the present disclosure, the spatial prediction information may represent the prediction direction enabling the optimal spatial prediction corresponding to each of the four sub data blocks in two bits. In this case, the spatial prediction information may be represented in eight bits.

FIG. 9 illustrates a prediction table according to an embodiment of the present disclosure.

Referring to FIG. 9, the prediction table may be assumed to be generated by 64 representative values each having 24 bits. For example, the prediction table may be generated by a RV table, a representative value of the neighboring pixels (surround pixel value), and a certain constant color value (constant value).

According to an embodiment of the present disclosure, the RV table may include, e.g., 32 RVs corresponding to 32 pixels. The representative values of the neighboring pixels may include, e.g., 16 representative values corresponding to, e.g., 16 neighboring pixels, and the color values may also include, e.g., 16 color values.

In such case, the prediction table may be generated by 64 pixel values. Corresponding to each of the 64 pixel values constituting the prediction table, the representative value may be defined using, e.g., 24 bits. For example, the 64 representative values may be allocated with six-bit unique prediction table indexes.

According to an embodiment of the present disclosure, the encoder may generate error correction encoding information based on a certain algorithm corresponding to the number of erroneous sub data blocks using the pre-generated prediction table referring to FIG. 9.

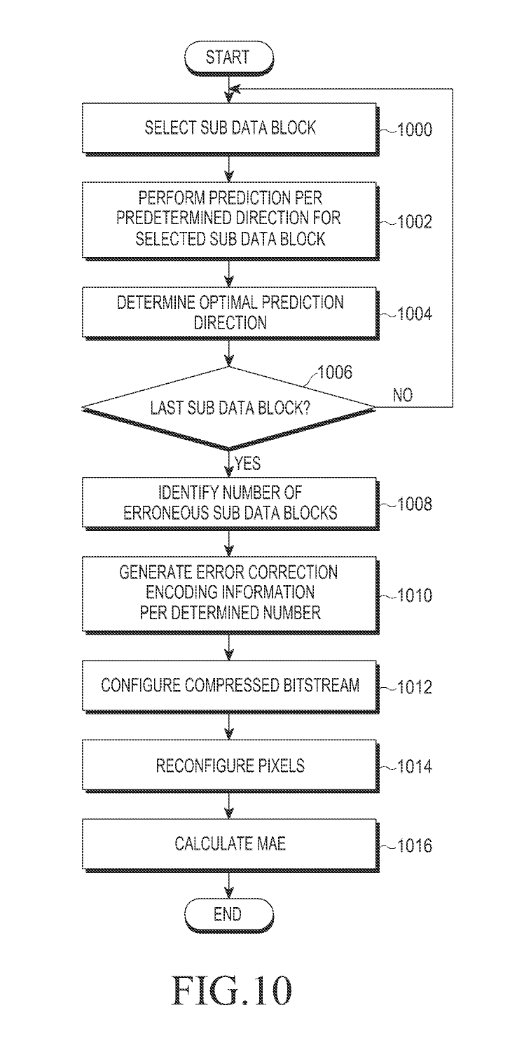

FIG. 10 is a flowchart illustrating a subroutine as per compression mode 1 in an encoder according to an embodiment of the present disclosure.

Referring to FIG. 10, it may be assumed that a data block obtained by splitting one image frame is split into sub data blocks with a certain size that are then processed.

According to an embodiment of the present disclosure, in operation 1000, the encoder 600 may select one of multiple sub data blocks obtained by splitting a data block selected as a target for encoding. The sub data blocks may be sequentially selected by the indexes respectively allocated to the sub data blocks. For example, when a data block with a size 8×2 (16 pixels) is split into four sub data blocks with a size 2×2 (four pixels), the encoder 600 may sequentially select the four sub data blocks.

According to an embodiment of the present disclosure, in operation 1002, the encoder 600 may perform spatial prediction on the selected sub data block, corresponding to each of certain prediction directions. In operation 1004, the encoder 600 may determine the optimal prediction direction based on the result of the spatial prediction performed per certain prediction direction.

In operation 1006, the encoder 600 may determine whether the optimal prediction direction for all the sub data blocks is determined. For example, eight-bit spatial prediction information may be configured through spatial prediction on the four sub data blocks obtained by splitting one data block.

Upon failure to determine the optimal prediction direction on all the sub data blocks, the encoder 600 may repeatedly perform the process of determining the prediction direction as per spatial prediction in operations 1000 to 1006.

The encoder 600, when spatial prediction on all the sub data blocks is complete, may configure erroneous sub data block selection information and error correction encoding information to be used for error correction in operations 1008 and 1010.

The encoder 600 may include algorithms respectively corresponding to multiple different scenarios to configure the error correction encoding information. For example, the encoder 600 may include an algorithm in which the error correction encoding information is configured by different scenarios depending on the number of sub data blocks with errors (hereinafter, denoted “erroneous sub data blocks”) among the sub data blocks that has undergone spatial prediction.

For example, when one data block is split into four sub data blocks, the number of erroneous sub data blocks will be determined to be four or less. In such case, the encoder 600 may include an algorithm that is based on four different scenarios corresponding to the number of erroneous sub data blocks.

According to an embodiment of the present disclosure, in operation 1008, the encoder 600 may count the erroneous sub data blocks based on a spatial prediction result and may identify the number of erroneous sub data blocks by the counted value. Upon counting, the encoder 600 may consider sub data blocks with an error rate as per spatial prediction larger than 0 as erroneous sub data blocks.

According to an embodiment of the present disclosure, the encoder 600, if the number of erroneous sub data blocks is identified, may generate erroneous sub data block selection information considering the identified number of erroneous sub data blocks. For example, when, among the four sub data blocks, first and third sub data blocks have errors, erroneous sub data block selection information of ‘1010’ may be generated.

In operation 1010, according to an embodiment of the present disclosure, the encoder 600 may generate error correction encoding information based on an algorithm prepared corresponding to the identified number of erroneous sub data blocks.

According to an embodiment of the present disclosure, when the number of erroneous sub data blocks is one, the encoder 600 may provide an algorithm for generating error correction encoding information for the one erroneous sub data block.

According to an embodiment of the present disclosure, when the number of erroneous sub data blocks is two, the encoder 600 may provide an algorithm for generating error correction encoding information for the two erroneous sub data blocks.

According to an embodiment of the present disclosure, for other numbers of erroneous sub data blocks, the encoder 600 may provide an algorithm for generating error correction encoding information appropriate for the number of the erroneous sub data blocks.

According to an embodiment of the present disclosure, the encoder 600 may apply different algorithms for generating error correction encoding information depending on the number of erroneous sub data blocks. In such case, the encoder 600 may efficiently distribute the bits constituting the error correction encoding information to the erroneous sub data blocks considering the accumulated errors of each sub data block.

For example, the error correction encoding information may be generated corresponding to each of the pixels constituting the erroneous sub data block. The error correction encoding information corresponding to each pixel may be generated using a RV or a prediction table index.

According to an embodiment of the present disclosure, the encoder 600 may previously generate a prediction table to obtain the RV or prediction table index for generating the error correction encoding information. For example, the prediction table may be generated by a RV table corresponding to a unique prediction data index, a RV of neighboring pixels, and certain constant color values. The RV table may include a RV corresponding to the original value of each of all the pixels constituting one image frame.

The encoder 600 may generate error correction encoding information based on a certain algorithm corresponding to the number of erroneous sub data blocks using the pre-generated prediction table.

When generating the error correction encoding information, the encoder 600 may configure a compressed bitstream by combining two-bit mode selection information, eight-bit spatial prediction information, four-bit erroneous sub data block selection information, and error correction encoding information in operation 1012.

According to an embodiment of the present disclosure, in operation 1014, the encoder 600 may reconfigure the data block before compression, i.e., the original data block, using the configured compressed bitstream. In operation 1016, the encoder 600 may calculate an error rate MAE as per compression mode 1 using the original data block and the reconfigured data block.

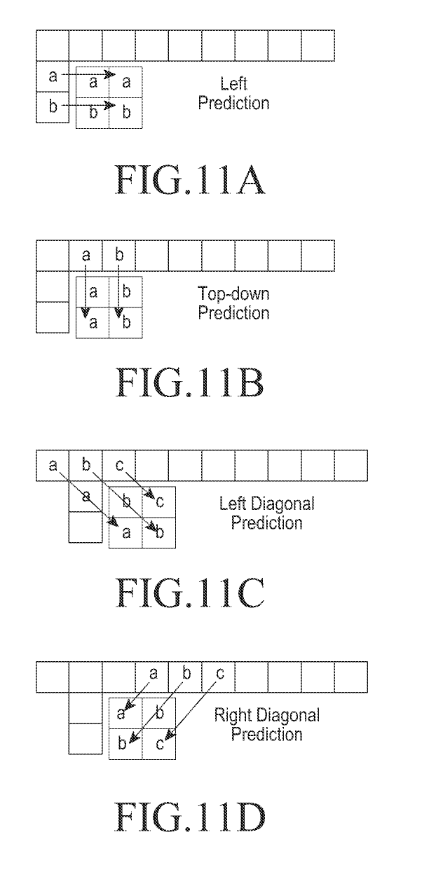

FIGS. 11A, 11B, 11C, and 11D illustrate methods of performing spatial prediction on selected sub data blocks according to an embodiment of the present disclosure. For example, spatial prediction may be performed on sub data blocks selected in four certain prediction directions, respectively.

FIG. 11A illustrates a method of performing spatial prediction from left to right (left prediction) according to an embodiment of the present disclosure.

Referring to FIG. 11A, each of the pixel values constituting the selected sub data block may be predicted by the pixel value positioned at a left side of the selected sub data block.

According to an embodiment of the present disclosure, two upper pixel values among the four pixels constituting the selected sub data block may be predicted as ‘a’ that is the pixel value of the upper pixel of the two pixels positioned at the left side of the selected sub data block. Two lower pixel values among the four pixels constituting the selected sub data block may be predicted as ‘b’ that is the pixel value of the lower pixel of the two pixels positioned at the left side of the selected sub data block.

FIG. 11B illustrates a method of performing spatial prediction from top to down (top-down prediction) according to an embodiment of the present disclosure.

Referring to FIG. 11B, each of the pixel values constituting the selected sub data block may be predicted by the pixel value positioned at an upper side of the selected sub data block.

According to an embodiment of the present disclosure, two left pixel values among the four pixels constituting the selected sub data block may be predicted as ‘a’ that is the pixel value of the left pixel of the two pixels positioned at the upper side of the selected sub data block. Two right pixel values among the four pixels constituting the selected sub data block may be predicted as ‘b’ that is the pixel value of the right pixel of the two pixels positioned at the upper side of the selected sub data block.

FIG. 11C illustrates a method of performing spatial prediction in a diagonal direction from left/upper side to right/lower side (left diagonal prediction) according to an embodiment of the present disclosure.

Referring to FIG. 11C, each of the pixel values constituting the selected sub data block may be predicted by the pixel value positioned at a left/upper side of the selected sub data block.

According to an embodiment of the present disclosure, one left and lower pixel value among the four pixels constituting the selected sub data block may be predicted as ‘a’ that is the pixel value of the upper pixel (the pixel positioned at the left/upper side) of the two pixels positioned at the left side of the selected sub data block. The left and upper pixel value and right and lower pixel value among the four pixels constituting the selected sub data block may be predicted as ‘b’ that is the pixel value positioned at the left/upper side. One right and upper pixel value among the four pixels constituting the selected sub data block may be predicted as ‘c’ that is the pixel value of the right pixel (the pixel positioned at the left/upper side) of the two pixels positioned at the upper side of the selected sub data block.

FIG. 11D illustrates a method of performing spatial prediction in a diagonal direction from right/upper side to left/lower side (right diagonal prediction) according to an embodiment of the present disclosure.

Referring to FIG. 11D, each of the pixel values constituting the selected sub data block may be predicted by the pixel value positioned at a right/upper side of the selected sub data block.

According to an embodiment of the present disclosure, one left and upper pixel value among the four pixels constituting the selected sub data block may be predicted as ‘a’ that is the pixel value of the right pixel (the pixel positioned at the right/upper side) of the two pixels positioned at the upper side of the selected sub data block. The right and upper pixel value and left and lower pixel value among the four pixels constituting the selected sub data block may be predicted as ‘b’ that is the pixel value positioned at the right/upper side. One right and lower pixel value among the four pixels constituting the selected sub data block may be predicted as ‘c’ that is the pixel value positioned at the right/upper side.

In connection with FIG. 11A to 11D, the pixel values constituting one sub data block have been predicted per present direction. However, when one data block is split into a plurality of sub data blocks, the remaining sub data blocks may also be subjected to spatial prediction per certain direction by the operation proposed above.

The encoder 600 may determine one optimal prediction direction among the prediction directions certain per sub data block. As an example, the encoder 600 may calculate an error rate MAE based on the pixel values predicted for four prediction directions and may determine, as the optimal prediction direction, the prediction direction that presents the minimum error rate among the calculated per-prediction direction error rates.

Since there are assumed to be four prediction directions, the optimal prediction direction may be represented as, e.g., a two-bit identification bit value. In such case, the spatial prediction information representing the four optimal prediction directions determined for four sub data blocks obtained by splitting the data block may be defined by an eight-bit (4×2) identification bit value.

The following Table 1 represents an example of defining identification bit values respectively indicating the four prediction directions.

TABLE 1

| Identification bit values | Prediction direction |
|---|---|
| 00 | Left prediction (FIG. 11A) |
| 01 | Top-down prediction (FIG. 11B) |
| 10 | Left diagonal prediction (FIG. 11C) |
| 11 | Right diagonal prediction (FIG. 11D) |

FIG. 12 illustrates a compressed bitstream generated by an encoder based on each compression mode according to an embodiment of the present disclosure.

Referring to FIG. 12, examples of compressed bitstreams respectively corresponding to when the number of erroneous sub data blocks of the four sub data blocks is one, two, three, and four.

According to an embodiment of the present disclosure, the compressed bitstream may include mode selection information (two bits) 1210, spatial prediction information (eight bits) 1212, erroneous sub data block selection information (four bits) 1214, and error correction encoding information 1216 to 1253 (not exceeding 82 bits). Different error correction encoding information may be defined depending on the number of erroneous sub data blocks. For example, the error correction encoding information not exceeding 82 bits may mean that the maximum size of error correction encoding information that may be generated by the encoder 600 corresponding to the data block does not exceed 82 bits.

According to an embodiment of the present disclosure, the mode selection information 1210 may be information for indicating the compression mode used for encoding the data block. The spatial prediction information 1212 may be information for indicating the optimal prediction direction for spatial prediction of each of the four sub data blocks obtained by splitting the data block.

The erroneous sub data block selection information 1214 may be information for identifying at least one sub data block with an error among the sub data blocks obtained by splitting one data block. For example, the erroneous sub data block selection information 1214 may include four bits. The four bits of the erroneous sub data block selection information 1214 may respectively correspond to the four sub data blocks. In such case, each of the bits constituting the erroneous sub data block selection information 1214 may represent whether its corresponding sub data block has an error.

According to an embodiment of the present disclosure, the error correction encoding information 1216 to 1253 may be information to be used for error correction on the erroneous sub data block. According to an embodiment of the present disclosure, the error correction encoding information may include error correction information and bitmap information corresponding to the erroneous sub data block. According to an embodiment of the present disclosure, the error correction encoding information may have different formats depending on the number of erroneous sub data blocks. This is further described below.

According to an embodiment of the present disclosure, the bitmap information may be information for identifying one pixel with a minimum error among the pixels constituting the erroneous sub data block and the other three pixels. According to an embodiment of the present disclosure, the bitmap information may include four bits. According to an embodiment of the present disclosure, the four bits of the bitmap information may respectively correspond to the four pixels. According to an embodiment of the present disclosure, each bit of the bitmap information may indicate whether the error correction code of its corresponding pixel is configured by a prediction table index or by a representative value.

According to an embodiment of the present disclosure, the error correction information may be information to be used for error correction on the erroneous sub data block. For example, the error correction information may be configured by a prediction table index and representative values selected in the prediction table.

Now described is an operation for generating a compressed bitstream corresponding to each of the examples where there are one, two, three, or four erroneous sub data blocks.

According to an embodiment of the present disclosure, when there is one erroneous sub data block, the encoder 600 may generate 82-bit error correction encoding information in addition to the mode selection information (two bits) 1210, spatial prediction information (eight bits) 1212, and erroneous sub data block selection information (four bits).

According to an embodiment of the present disclosure, the encoder 600 may set one bit value corresponding to an erroneous sub data block among the four bits constituting the erroneous sub data block selection information 1214 to be different from the remaining bit values. The erroneous sub data block selection information 1214, when the decoder restores the four sub data blocks, may be used to identify an erroneous sub data block among the four sub data blocks.

According to an embodiment of the present disclosure, the encoder 600 may generate error correction encoding information for one sub data block with an error among the four sub data blocks. For example, the encoder 600 may generate error correction encoding information by the error correction information 1218 and the bitmap information 1216 for one erroneous sub data block.

According to an embodiment of the present disclosure, the encoder 600 may select a pixel with a minimum error among the four pixels constituting the erroneous sub data block in order to configure the bitmap information 1216 and the error correction information 1218. For example, the encoder 600 may configure the bitmap information 1216 by selecting one pixel with the minimum error among the four pixels.

According to an embodiment of the present disclosure, the bitmap information 1216 may be used for identifying one pixel with a minimum error among the pixels constituting the erroneous sub data block and the other three pixels. The bitmap information 1216 may include, e.g., four bits. The four bits of the bitmap information 1216 may respectively correspond to the four pixels. In this case, each bit of the bitmap information 1216 may indicate whether the error correction code of its corresponding pixel is configured by a prediction table index or by a representative value.

According to an embodiment of the present disclosure, the encoder 600 may configure the error correction information 1218 on the pixel with the minimum error by a six-bit prediction table index. For example, the encoder 600 may discover a representative value closest to the pixel value calculated by performing spatial prediction on the pixel with the minimum error among the 64 representative values constituting the prediction table and may configure the error correction information on the pixel with the minimum error by the prediction table index allocated corresponding to the discovered representative value.

According to an embodiment of the present disclosure, the encoder 600 may configure the error correction information 1218 by the representative values selected from among the 32 representative values constituting the RV table corresponding to each of the other three pixels than the pixel with the minimum error.

For example, for the error correction information on each of the three remaining pixels, the representative value closest to the pixel value calculated by performing spatial prediction on the corresponding pixel among the 32 representative values constituting the RV table. The encoder 600 may configure error correction information by the representative values discovered for each of the three remaining pixels. For example, when the representative value is defined in 24 bits, the error correction information on the three remaining pixels may be configured in 72 bits (3×24 bits).

Further, the encoder 600 may generate the error correction encoding information by the prediction table index corresponding to the pixel with the minimum error and representative values respectively corresponding to the three remaining pixels. For example, since the bitmap information may have four bits, the prediction table index may have six bits, and the total number of bits of the representative values respectively corresponding to the three remaining pixels is 72 bits, the number of bits of the error correction encoding information may be 82 bits.

According to an embodiment of the present disclosure, the encoder 600 may generate a 92-bit compressed bitstream including two-bit mode selection information, eight-bit spatial prediction information, four-bit erroneous sub data block selection information, and 82-bit error correction encoding information.

For example, the two-bit mode selection information may indicate that compression mode 1 has been used for encoding the selected data block. The eight-bit spatial prediction information may indicate a prediction block for spatial prediction on each of the four sub data block obtained by splitting the selected data block. The erroneous sub data block selection information may be used to identify the sub data block with an error among the sub data blocks.

According to an embodiment of the present disclosure, the error correction encoding information may include a four-bit bitmap and error correction information configured for each pixel not to exceed 78 bits. The error correction information may be configured by a prediction data index (six bits) obtained from the prediction table using the pixel value of the pixel with the minimum error and three representative values (72 bits (3×24 bits)) obtained from the RV table using the respective pixel values of the three remaining pixels.

According to an embodiment of the present disclosure, when there are two erroneous sub data blocks, the encoder 600 may generate 80-bit error correction encoding information in addition to the mode selection information (two bits) 1210, spatial prediction information (eight bits) 1212, and erroneous sub data block selection information (four bits).

For example, the encoder 600 may set two bit values corresponding to two erroneous sub data blocks among the four bits constituting the erroneous sub data block selection information 1214 to be different from the two remaining bit values. The erroneous sub data block selection information 1214, when the decoder restores the four sub data blocks, may be used to identify the two erroneous sub data blocks among the four sub data blocks.

According to an embodiment of the present disclosure, the encoder 600 may generate error correction encoding information for two sub data block with errors among the four sub data blocks. For example, the encoder 600 may generate error correction encoding information by the error correction information 1222 and 1226 and the bitmap information 1220 and 1224 for each of the two erroneous sub data blocks.

For example, the encoder 600 may select a first pixel with the maximum error and a second pixel with the second maximum error from among the four pixels corresponding to each of the erroneous sub data blocks in order to configure the bitmap information 1220 and 1224 and error correction information 1222 and 1226. The encoder 600 may configure the bitmap information 1220 and 1224 corresponding to each erroneous sub data block by selecting the first and second pixels for each of the two erroneous sub data blocks.

According to an embodiment of the present disclosure, the bitmap information 1220 and 1224 may be used to identify the pixel with the maximum error and the pixel with the second maximum error among the pixels constituting the erroneous sub data block. The bitmap information 1220 and 1224 may include, e.g., eight bits. The eight bits of the bitmap information 1220 and 1224 may respectively correspond to the four pixels. In such case, the bitmap information 1220 and 1224 may be used to identify the pixel (first pixel) whose error correction code has been configured by the prediction table index when the decoder performs decoding. Further, the bitmap information 1220 and 1224 may be used to identify the pixel (second pixel) whose error correction code has been configured by the representative value when the decoder performs decoding.

According to an embodiment of the present disclosure, the encoder 600 may configure the error correction information for the first pixel with the maximum error per erroneous sub data block with a representative value of 24 bits and may configure the error correction information for the second pixel with the second maximum error with a prediction table index of six bits.

In such case, the error correction encoding information corresponding to each of the two erroneous sub data blocks may include eight-bit bitmap information 1220 and 1224, a 24-bit representative value, and a six-bit prediction table index. Thus, the whole error correction encoding information may have 76 bits.

According to an embodiment of the present disclosure, the encoder 600 may obtain a representative value closest to the pixel value calculated by spatial prediction on the first pixel among the 64 representative values constituting the prediction table. The encoder 600 may discover a representative value closest to the pixel value calculated by performing spatial prediction on the second pixel among the 64 representative values constituting the prediction table and may obtain the prediction table index allocated corresponding to the discovered representative value.

The encoder 600 may obtain a representative value for the first pixel for each of the two erroneous sub data blocks and may obtain a prediction data index for the second pixel. In this case, the encoder 600 may configure the error correction information 1222 and 1226 of each of the two erroneous sub data blocks by combining the representative value obtained for the first pixel and the prediction data index obtained for the second pixel.

According to an embodiment of the present disclosure, the encoder 600 may generate error correction encoding information per erroneous sub data block by combining the bitmap information 1220 and 1224 and the error correction information 1222 and 1226. Since the bitmap information 1220 and 1224 has, e.g., eight bits, and the prediction table index has, e.g., six bits, and the representative value has, e.g., 24 bits, the number of bits of the error correction encoding information for one erroneous sub data block is, e.g., 38. Thus, the number of bits of the error correction encoding information for two erroneous sub data blocks may be 76 bits.

For example, the encoder 600 may generate a 90-bit compressed bitstream by adding, to the 76-bit error correction encoding information, the two-bit mode selection information, the eight-bit spatial prediction information, and the four-bit erroneous sub data block selection information.

In this case, the two-bit mode selection information may indicate that compression mode 1 has been used for encoding the selected data block. The eight-bit spatial prediction information may indicate a prediction block for spatial prediction on each of the four sub data block obtained by splitting the selected data block. The erroneous sub data block selection information may be used to identify the two sub data blocks with an error among the sub data blocks.

For example, the error correction encoding information may include 30-bit error correction information and an eight-bit bitmap corresponding to each of the two erroneous sub data blocks. The error correction information may be configured by the representative value (24 bits) obtained from the prediction table using the pixel value of the first pixel with the maximum error and the prediction data index (six bits) obtained from the prediction table using the second pixel value with the second minimum error.

According to an embodiment of the present disclosure, when there are three erroneous sub data blocks, the encoder 600 may generate 86-bit error correction encoding information in addition to the mode selection information (two bits) 1210, spatial prediction information (eight bits) 1212, and erroneous sub data block selection information (four bits).

In this case, the encoder 600 may configure erroneous sub data block selection information 1214 for identifying three sub data blocks with an error among four sub data blocks. For example, the encoder 600 may set the bit values corresponding to three erroneous sub data blocks among the four bits constituting the erroneous sub data block selection information 1214 to be different from one remaining bit value. The erroneous sub data block selection information 1214 with the bit values set as above, when the decoder decodes the four sub data blocks, may be used to identify the three erroneous sub data blocks among the four sub data blocks.

According to an embodiment of the present disclosure, the encoder 600 may generate error correction encoding information for the three sub data block with errors among the four sub data blocks. For example, the encoder 600 may generate the error correction encoding information by the bitmap information 1230, 1232, and 1234, error correction information 1231, 1233, and 1235, and sub data block differentiation information 1236, 1237, and 1238 for each of the three erroneous sub data blocks.

For example, the encoder 600 may identify the degree of error for each of the three erroneous sub data blocks in order to configure the bitmap information 1230, 1232, and 1234, error correction information 1231, 1233, and 1235, and sub data block differentiation information 1236, 1237, and 1238. The encoder 600 may differentiate the three erroneous sub data blocks based on the identified degree of error. For example, the encoder 600 may determine the erroneous sub data block with the maximum error as a first erroneous sub data block, the erroneous sub data block with the minimum error as a third erroneous sub data block, and one remaining erroneous sub data block as a second erroneous sub data block.

According to an embodiment of the present disclosure, the encoder 600 may generate error correction encoding information of different formats for each of the first, second, and third erroneous sub data blocks. The different formats may mean that the error correction encoding information has different configurations.

According to an embodiment of the present disclosure, the encoder 600 may generate error correction encoding information for the first erroneous sub data block by error correction information 1231 including a two-level bitmap (eight bits) 1230, one representative value, and one prediction table index and sub data block differentiation information (two bits) 1236 allocated to the first erroneous sub data block. The error correction encoding information for the first erroneous sub data block may have 40 bits.

For example, the encoder 600 may generate error correction encoding information for the second erroneous sub data block by error correction information 1233 including a one-level bitmap (four bits) 1232 and one representative value and sub data block differentiation information (two bits) 1237 allocated to the second erroneous sub data block. The error correction encoding information for the second erroneous sub data block may have 30 bits.

According to an embodiment of the present disclosure, the encoder 600 may generate error correction encoding information for the third erroneous sub data block by error correction information 1235 including a one-level bitmap (four bits) 1234 and one prediction table index and sub data block differentiation information (two bits) 1238 allocated to the third erroneous sub data block. The error correction encoding information for the third erroneous sub data block may have 12 bits.

In this case, the encoder 600 may generate error correction encoding information of 82 bits including the 40-bit error correction encoding information for the first erroneous sub data block, the 30-bit error correction encoding information for the second erroneous sub data block, and the 12-bit error correction encoding information for the third erroneous sub data block.

According to an embodiment of the present disclosure, the encoder 600 may configure the compressed bitstream by mode selection information (two bits) 1210, spatial prediction information (eight bits) 1212, erroneous sub data block selection information (four bits) 1214, and error correction encoding information (82 bits).

According to an embodiment of the present disclosure, when there are four erroneous sub data blocks, the encoder 600 may generate 84-bit error correction encoding information in addition to the mode selection information (two bits) 1210, spatial prediction information (eight bits) 1212, and erroneous sub data block selection information (four bits).

In this case, the encoder 600 may configure erroneous sub data block selection information 1214 for identifying the four sub data blocks with an error. For example, the encoder 600 may set all the bits constituting the erroneous sub data block selection information 1214 to a previously agreed value. The previously agreed value may mean a bit value agreed to indicate that the corresponding sub data block has an error. The erroneous sub data block selection information 1214, when the decoder restores the four sub data blocks, may be used to identify that the four sub data blocks all have an error.

According to an embodiment of the present disclosure, the encoder 600 may generate error correction encoding information for the four erroneous sub data blocks with an error. For example, the encoder 600 may classify three erroneous sub data blocks into two groups considering the degree of error occurrence and may generate error correction encoding information of different formats per classified group. The different formats may mean that the error correction encoding information has different configurations.

According to an embodiment of the present disclosure, the encoder 600 may identify the degree of error for each of the erroneous sub data blocks and may classify the erroneous sub data blocks into two groups considering the identified degree of error. For example, the encoder 600 may determine two erroneous sub data blocks with a relatively larger error to belong to a first erroneous sub data block group and two erroneous sub data blocks with a relatively smaller error to belong to a second erroneous sub data block group.

For example, error correction encoding information for each of the two erroneous sub data blocks in the first erroneous sub data block group may be generated by a bitmap (four bits) 1240 and 1242, one representative value (24 bits) 1241 and 1243, and sub data block differentiation information (one bit) 1250 and 1251. The error correction encoding information for each erroneous sub data block in the first erroneous sub data block group may have 29 bits.

According to an embodiment of the present disclosure, error correction encoding information for each of the two erroneous sub data blocks in the second erroneous sub data block group may be generated by a bitmap (four bits) 1244 and 1246, one prediction table index (6 bits) 1245 and 1247, and sub data block differentiation information (one bit) 1252 and 1253. The error correction encoding information for each erroneous sub data block in the second erroneous sub data block group may have 11 bits.

In this case, the encoder 600 may generate error correction encoding information of 80 bits including 58-bit error correction encoding information for the two erroneous sub data blocks in the first erroneous sub data block group and 22-bit error correction encoding information for the two erroneous sub data blocks in the second erroneous sub data block group.

According to an embodiment of the present disclosure, the encoder 600 may configure the compressed bitstream by mode selection information (two bits) 1210, spatial prediction information (eight bits) 1212, erroneous sub data block selection information (four bits) 1214, and error correction encoding information (80 bits).

Second described is configuring compressed data using compression mode 2 that is one of various compression schemes.

The encoding operation in compression mode 2 (codebook indexing) may include an operation for encoding each pixel value constituting a data block with indexes of representative values constituting a codebook (representative value (RV) table).

For example, since one color component includes eight bits, and one pixel includes three color components R, G, B, one pixel value may have 24 (=8×3) bits. The codebook (RV table) to be used upon encoding in compression mode 2 may include, e.g., 32 representative values. In this case, each representative value (24 bits) in the codebook (RV table) may be assigned with a five-bit codebook index (or representative value (RV) index).

For example, the encoder 600 may discover the representative value closest to the pixel value among the 32 representative values constituting the codebook (RV table) and may replace the pixel value with a five-bit codebook index assigned to the discovered representative value. Thus, the 24-bit pixel value may be encoded into the five-bit codebook index.

According to an embodiment of the present disclosure, a compression rate of 4:1 may be targeted. In this case, a resultant value obtained by encoding one data block including 384 (=16×24) bits is supposed to be 96 (=384÷4) bits. The reason why one data block includes 384 bits is that one data block includes 16 pixels each having 24 bits.

According to an embodiment of the present disclosure, when the 16 pixels constituting one data block are encoded into the codebook index, e.g., 80 (=5×16) bits may be obtained as a result of the encoding. The 80 bits lack 14 bits as compared with the target bit count, 96 bits. In such case, 14 redundancy bits occur. Compression mode 2 may be utilized to perform error correction on, e.g., the 14 redundancy bits.

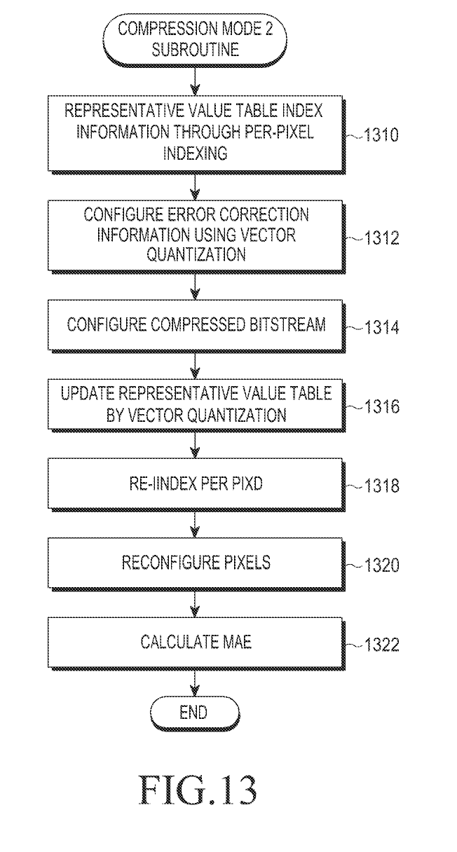

FIG. 13 is a flowchart illustrating a subroutine as per compression mode 2 according to an embodiment of the present disclosure.

Referring to FIG. 13, one data block may include 16 pixels, and each pixel value may be encoded at a compression rate of 4:1.

In operation 1310, the encoder 600 may perform indexing on each pixel to configure codebook (RV table) index information. For example, the encoder 600 may compare the 24-bit pixel value with the representative values constituting the codebook (RV table), and as a result of the comparison, may select a representative value closest to the pixel value. The encoder 600, when selecting the representative value corresponding to one pixel, may obtain the five-bit codebook (RV table) index assigned to the selected representative value in the codebook (RV table). The encoder 600 may allow the pixel value to be replaced with the obtained five-bit codebook (RV table) index. For example, the encoder 600 may encode the 24-bit pixel value into the five-bit codebook (RV table) index.

According to an embodiment of the present disclosure, the encoder 600 may perform encoding on all the pixels constituting one data block by the same method. The encoder 600, when encoding on all the pixels is complete, may obtain 80-bit indexing information (Indices to RV table).

In operation 1312, the encoder 600, when encoding on all the pixels is complete, may configure error correction information using vector quantization. The error correction information may include information (Base Index) for identifying the pixel with the maximum error in one data block and information regarding the direction and length of the vector (V) for error correction.

In this case, the encoder 600 may select one base pixel for configuring error correction information. The base pixel may be one of the pixels constituting one data block and may allow for selection of the pixel with the maximum error. The encoder 600, when the base pixel is selected, may perform vector quantization using the coordinate value of the target pixel desired to be obtained through error correction and the coordinate value of the base pixel. The encoder 600 may obtain the V defined by the coordinate of the base pixel and the coordinate of the target pixel through vector quantization. The V may be utilized to obtain the target pixel through error correction on the base pixel value.

The V may be defined by direction information and distance information. In this case, the encoder 600 may calculate the direction information and the distance information from the V. The encoder 600 may configure error correction information by the identification information representing the calculated direction information and distance information. For example, the direction information and the distance information of the V each may be defined in five bits, and the identification information indicating the base pixel may be defined in four bits. In this case, the error correction information may have 15 bits.

According to an embodiment of the present disclosure, in operation 1314, the encoder 600 may configure a compressed bitstream as a result of compression mode 2 encoding. The compressed bitstream may include compression mode selection information, codebook (RV table) index information and error correction information.

According to an embodiment of the present disclosure, the encoder 600 may perform vector quantization based on the codebook (RV table) index information and error correction information as per initial indexing. For example, the encoder 600 may reconfigure the representative value corresponding to each pixel by performing vector quantization. In operation 1316, the encoder 600 may update the RV constituting the codebook (RV table) by the representative values reconfigured corresponding to each pixel.

According to an embodiment of the present disclosure, in operation 1318, the encoder 600 may perform indexing again on the pixel values by searching the codebook (RV table) in which the representative values have been updated. The encoder 600 may re-index the pixels based on the codebook (RV table) with the updated representative values in order to reduce errors that occur in the pixels due to initial indexing.

In operation 1320, the encoder 600, when re-indexing is complete, may reconfigure the pixels based on the result of the re-indexing. In operation 1322, the encoder 600 may calculate an error rate MAE by the reconfigured pixels and the original pixels.

According to an embodiment of the present disclosure, the size of the codebook (RV table) in compression mode 2 may be varied, and scalar quantization or vector quantization may be used for error correction. Further, the values available for indexing may also be varied for changing quality. According to an embodiment of the present disclosure, a new temporary RV table, which includes some values in the RV table and/or some values adjacent to the pixel, may be created per pixel. The number of representative values constituting the codebook (RV table) and the number of values to be considered from the neighboring pixels may be varied.

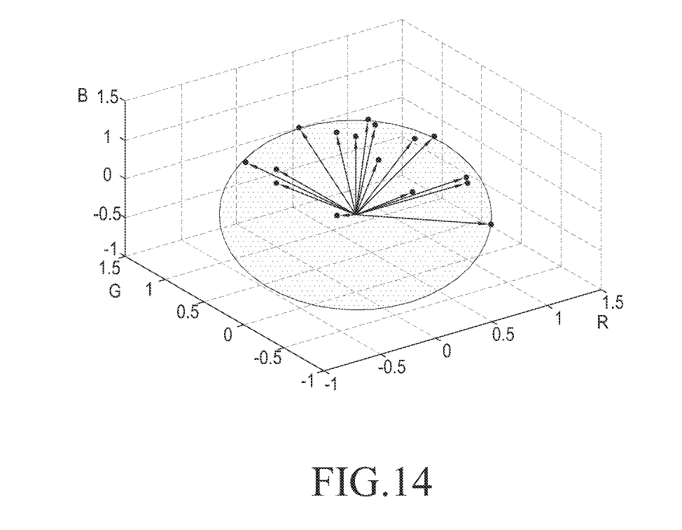

FIG. 14 illustrates a degree of error when encoding is performed in compression mode 2 according to an embodiment of the present disclosure.

Referring to FIG. 14, for example, an error rate predicted when one pixel value is replaced with representative values constituting the codebook (RV table) is represented as a vector on the coordinates of three color components R, G, B is illustrated.

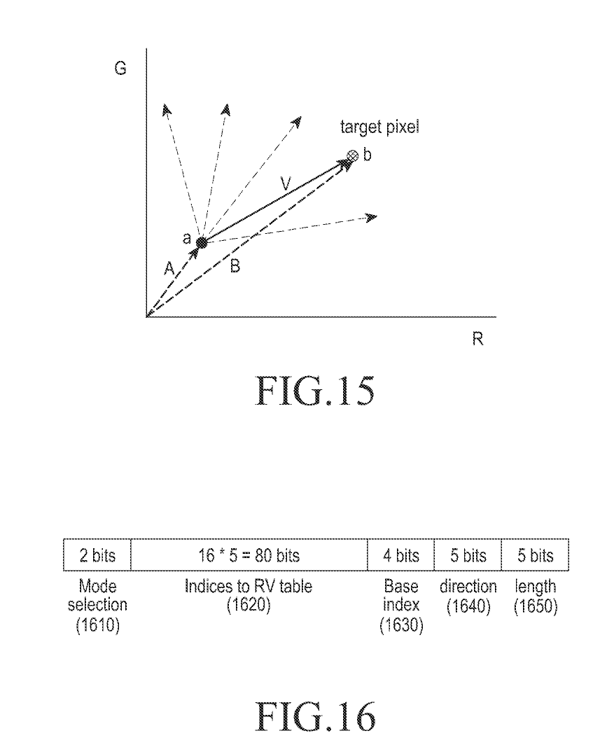

FIG. 15 illustrates a method of obtaining a vector for error correction in compression mode 2 according to an embodiment of the present disclosure.

Referring to FIG. 15, the vector for error correction may be defined by coordinates of two color components green and red (G, R) for ease of description.

According to an embodiment of the present disclosure, the length and direction of the vector for error correction may be utilized in compression mode 2. For example, among 16 pixels constituting one data block, one pixel with an error may be selected. In this case, the pixel with the maximum error among the 16 pixels may be selected.

According to an embodiment of the present disclosure, a V connecting the coordinate a green and blue (G, B) of the selected pixel (base pixel) and the coordinate b (G′, B′) of the target pixel may be obtained. The V may be obtained by performing vector quantization considering the coordinate a (G, B) of the selected pixel (base pixel) and the coordinate b (G′, B′) of the target pixel.

According to an embodiment of the present disclosure, the vector (V) may be calculated using the vector (A) connecting a base coordinate (0, 0) with the coordinate a (G, B) of the selected pixel and the vector (B) connecting the base coordinate (0, 0) with the coordinate b of the selected pixel.

For example, the 14 bits to be used for error correction may include four bits indicating the selected vector for obtaining the V, five bits representing the direction of the V, and five bits representing the quantized distance of the vector (V).

According to an embodiment of the present disclosure, the encoder 600 may reconfigure the representative values by performing vector quantization using the 14 bits for error correction and a resultant value of initial indexing. The encoder 600 may update the representative values constituting the codebook (RV table) based on the reconfigured result.

According to an embodiment of the present disclosure, the encoder 600 may re-index the pixels based on the updated codebook (RV table). The re-indexing may be performed for the purpose of reducing errors that may be shown in the pixels upon initial indexing.

FIG. 16 illustrates a compressed bitstream obtained by performing encoding in compression mode 2 according to an embodiment of the present disclosure.

Referring to FIG. 16, the compressed bitstream may include two-bit compression mode selection information (Mode selection) 1610, 80-bit codebook (RV table) index information (Indices to RV bits) 1620 configured through per-pixel indexing, and 14-bit error correction information. The error correction information may include five-bit direction information 1640, five-bit distance information 1650, and four-bit identification information 1630 indicating a base pixel.

Third described is configuring compressed data using compression mode 3 that is one of various compression schemes.

The encoding operation in compression mode 3 (4-level VQ-BTC with interpolation) may include an operation for compressing a data block based on a cluster of lower pixels constituting the data block.

For example, when encoding is performed on one data block including eight upper pixels and eight lower pixels, the eight lower pixels may be classified into four groups, and a 16-bit bitmap requiring two bits for each of the eight lower pixels may be configured based on the result of the classification. In this case, the bitmap may be used as information for recognizing the group into which each of the eight lower pixels has been classified.

According to an embodiment of the present disclosure, in another way to reconfigure the lower pixels, the encoder 600 may configure four groups into two pairs and may obtain two representative values respectively for the two pairs. For example, the encoder 600 may obtain the two representative values respectively corresponding to the pairs by an average of the pixel values of the four lower pixels included in each of the two groups constituting the pair.

For example, the encoder 600 may calculate a mean value corresponding to one pair by the average of the two representative values obtained from the pair. When the mean value is calculated, the encoder 600 may compute a vector formed as one representative value used to calculate the mean value. When the vector is computed, the encoder 600 may obtain direction information and length information corresponding to the computed vector.

The representative values respectively obtained for the two pairs, and the direction and length information may contain error correction information in the compressed bitstream.

For example, the encoder 600 may perform the reconfiguration with interpolation using different types of schemes using the lower pixels and the pixels constituting the upper line of the eight upper pixels. The encoder 600 may allocate an interpolation index to each of the different types of interpolation schemes and may configure an interpolation index set by the interpolation index corresponding to the optimal interpolation scheme for each of the eight upper pixels.

The compressed bitstream as per compression mode 3 may include a bitmap, an interpolation index set, and error correction information.

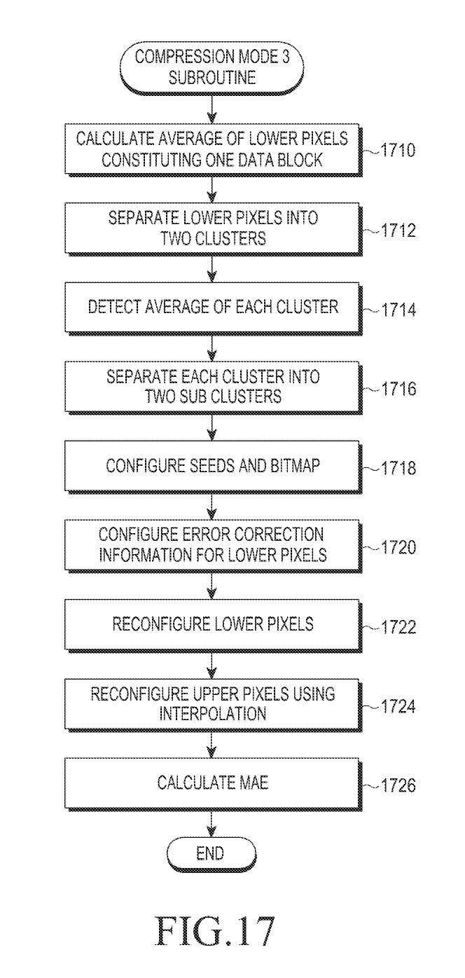

FIG. 17 is a flowchart illustrating a subroutine as per compression mode 3 in an encoder according to an embodiment of the present disclosure.

Referring to FIG. 17, one data block may include 16 (=8×2) pixels including eight upper pixels and eight lower pixels. The one data block may be encoded at a compression rate of 4:1.

According to an embodiment of the present disclosure, in operation 1710, the encoder 600 may detect an average of the pixel values of the eight lower pixels constituting one data block. For example, the pixel value may be defined by a luminance coefficient. In this case, the average is an average of the luminance coefficient of the lower pixels. The luminance coefficient may be calculated using a standard YCbCr color conversion technique.

According to an embodiment of the present disclosure, in operation 1712, the encoder 600 may classify the lower pixels into two clusters by using the calculated average as a threshold. The encoder 600 may compare the luminance coefficient of each lower pixel with the average and may classify the lower pixels into two clusters using the result of the comparison. For example, the encoder 600 may configure one cluster of lower pixels having a luminance coefficient more than the average and may configure another cluster of lower pixels having a luminance coefficient less than the average.

In operation 1714, the encoder 600 may detect an average pixel value of the pixels in each cluster. According to an embodiment of the present disclosure, the encoder 600 may calculate an average of the luminance coefficients of the lower pixels belonging to each cluster.

In operation 1716, the encoder 600 may classify the lower pixels in each cluster into two sub clusters by using the average detected per cluster as a threshold. For example, the encoder 600 may compare the luminance coefficients of the lower pixels in one cluster with the average of the cluster and may classify the lower pixels into two sub clusters according to the result. The encoder 600 may compare the luminance coefficients of the lower pixels in the other cluster with the average of the cluster and may classify the lower pixels into two sub clusters according to the result.

By the above-described operation, the encoder 600 may classify the pixels constituting one data block into four sub clusters by the average. For example, the encoder 600 may classify eight lower pixels constituting one data block into two clusters for every four pixels using the average of all the luminance coefficients. The encoder 600 may classify the four lower pixels in each cluster into two sub clusters for every two pixels using the luminance coefficient average detected for each of the two clusters.

As a result, the eight lower pixels in one data block are supposed to be classified into four sub clusters including two pixels. Since the sub cluster is classified by the size of luminance coefficient of the pixel, each sub cluster may be differentiated by the size of luminance coefficient.

According to an embodiment of the present disclosure, in operation 1718, the encoder 600 may assign a seed to each sub cluster and may configure a bitmap for each seed.

For example, the encoder 600 may assign a seed to each of the four sub clusters using “00,” “01,” “10,” “11,” or “HH,” “HL,” “LH,” and “LL.” Hereinafter, the sub cluster assigned with seeds using “00,” “01,” “10,” “11,” or “HH,” “HL,” “LH,” and “LL” is denoted a ‘group.’

“00” or “HH” means that the pixel value has been determined to have a value larger than the average in the two times of classification. “01” or “HL” means that the pixel value has been determined to be larger than the average in the first classification, but has been determined to be less than the average. “10” or “LH” means that the pixel value has been determined to be less than the average in the first classification, but has been determined to be larger than the average. “11” or “LL” means that the pixel value has been determined to have a value less than the average in the two times of classification.

According to an embodiment of the present disclosure, the encoder 600 may configure a bitmap corresponding to the lower pixels with the seed assigned to each group, i.e., “00,” “01,” “10,” “11,” or “HH,” “HL,” “LH,” and “LL.” For example, in order to minimize the amount of information constituting the bitmap, the seed may be assigned to each group using “00,” “01,” “10,” and “11.”

The following Table 2 shows an example in which eight lower pixels are classified and seeds are assigned to each of the groups corresponding to the classifications.

TABLE 2

| Lower pixel differentiation | Group differentiation | Seed differentiation |
|---|---|---|
| pixel #1 | group #3 | 10 |
| pixel #2 | group #1 | 00 |
| pixel #3 | group #4 | 11 |
| pixel #4 | group #2 | 01 |
| pixel #5 | group #2 | 01 |
| pixel #6 | group #1 | 00 |
| pixel #7 | group #3 | 10 |
| pixel #8 | group #4 | 11 |

According to an embodiment of the present disclosure, referring to Table 2, the lower pixels are classified and seeds are assigned, the encoder 600 may configure a bitmap for identifying the seed assigned to each of the eight lower pixels. For example, when every two bits are assigned for identifying the seed assigned to each lower pixel, the bitmap is configured of a total of 16 (=8×2) bits. According to Table 2 above, the bitmap may be configured of “1000110101001011.”

According to an embodiment of the present disclosure, in operation 1720, the encoder 600 may configure error correction information for the lower pixels. The error correction information may include information on a RV and a vector. The information on the vector may include direction information and length information.

According to an embodiment of the present disclosure, to meet the compression rate of 4:1, the error correction information may be configured not to exceed 62 bits.

To that end, two schemes may be taken into account. For example, there may be a scheme using vector quantization and a scheme using scalar quantization.

According to an embodiment of the present disclosure, the scheme using vector quantization is described. The encoder 600 may obtain a RV for each sub group from the RV table. The representative value may be determined by an average of the pixels belonging to the sub group. The average may be an average of pixel values. For example, when the pixel value is defined with a luminance coefficient, the average may be obtained by averaging the luminance coefficients of the pixels in the sub group.

The encoder 600, when obtaining the representative values for four sub groups, may group the four obtained representative values into two pairs. The encoder 600 may compute a mean value between the two representative values constituting the pair by grouping. Since the mean value is computed for each pair, the encoder 600 may obtain two mean values. The encoder 600 may calculate the direction information and length information on the vector formed of the original representative value from the mean value obtained corresponding to each pair.

The encoder 600 may configure error correction information corresponding to one data block by the direction information and length information calculated for each pair and the representative values obtained for each sub group.

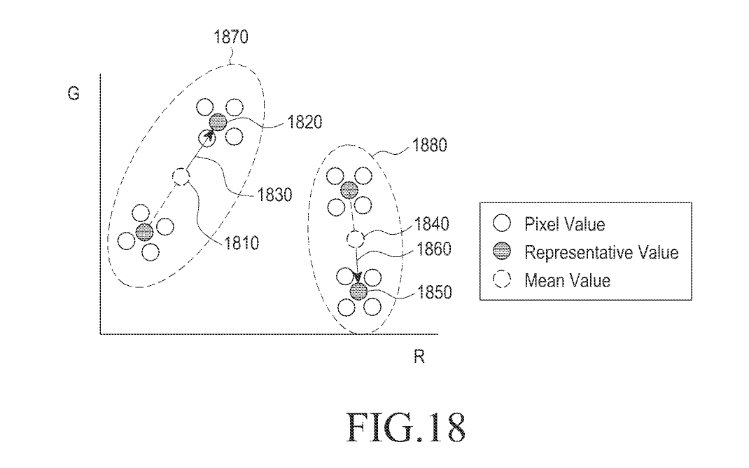

An embodiment of the scheme using vector quantization is described below with reference to FIG. 18.

According to an embodiment of the present disclosure, the scheme using scalar quantization is described. The encoder 600 may distribute bits in four representative values considering different cases. For example, when the four representative values are the same, the encoder 600 may encode the four representative values into a total of 24 bits. When the four representative values are different from each other, the encoder 600 may encode each of two of the four representative values into 16 bits and encode each of the two remaining representative values into 15 bits. The encoder 600 may configure error correction information on one data block using the resultant value of the encoding.

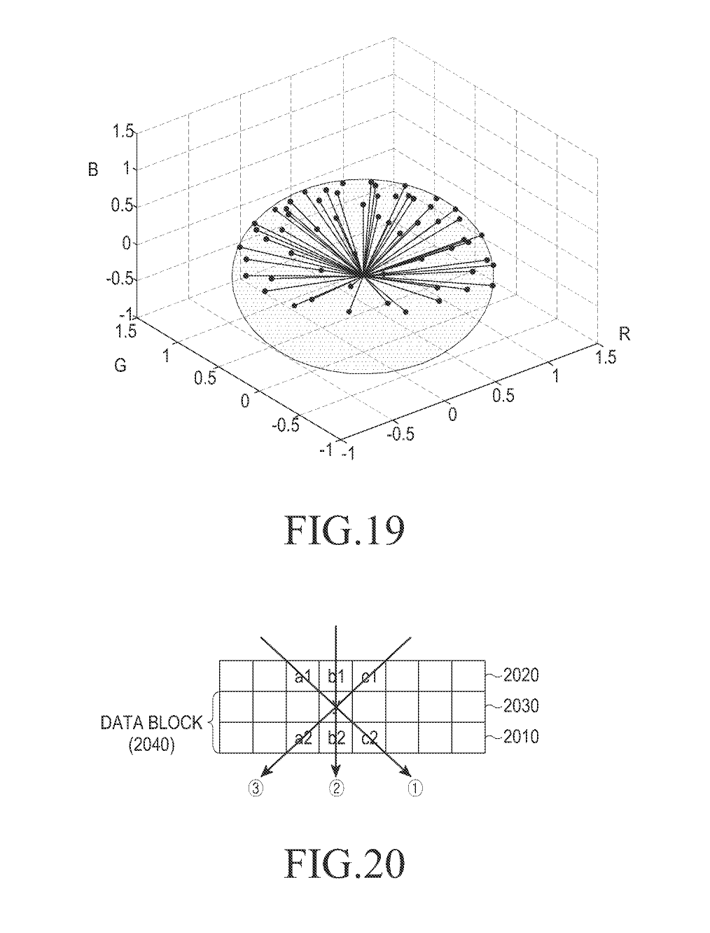

An embodiment of the scheme using scalar quantization is described below with reference to FIG. 19.

According to an embodiment of the present disclosure, in operation 1722, the encoder 600 may reconfigure the lower pixels constituting the data block based on the above encoding result. For example, the encoder 600 may reconfigure the lower pixels based on the error correction information and bitmap indicating the seed where each of the lower pixels belongs.

According to an embodiment of the present disclosure, in operation 1724, the encoder 600 may reconfigure the upper pixels constituting the data block using interpolation between the reconfigured lower pixels and the pixels of the previous line.

In operation 1726, the encoder 600 calculates an error rate MAE by the reconfigured lower and upper pixels and the pixels constituting the original data block according to an embodiment of the present disclosure.

FIG. 18 illustrates a method of obtaining a seed value or RV value upon encoding in compression mode 3 according to an embodiment of the present disclosure.

Referring to FIG. 18, the encoder 600 may compute mean values 1810 and 1840 by two representative values constituting one pair 1870 and 1880. For example, the encoder 600 may obtain each of the two representative values present in one pair 1870 and 1880 by an average of the pixel values of the four lower pixels included in two groups constituting the pairs 1870 and 1880. The encoder 600 may calculate the mean values 1810 and 1840 by the average of the two representative values constituting one pair 1870 and 1880.

The encoder 600 may obtain the direction information and length information defining vectors 1830 and 1860 that are oriented from the mean values 1810 and 1840 to the original representative value 1820 and 1850. According to an embodiment of the present disclosure, the encoder 600 may configure error correction information corresponding to each pair by the obtained mean value and vector information (direction information and length information) by obtaining the mean value and vector information (direction information and length information) corresponding to each pair.

For example, the encoder 600 should configure the error correction information not to exceed 62 bits. Accordingly, the encoder 600 may assign 18 bits to the mean value of each pair, six bits to the direction information, and seven bits to the length information.

FIG. 19 illustrates, upon encoding in compression mode 3, bits being distributed in four representative values in scalar quantization, according to an embodiment of the present disclosure.

FIG. 20 illustrates a method of reconfiguring pixels by interpolation upon encoding in compression mode 3 according to an embodiment of the present disclosure.

Referring to FIGS. 19 and 20, any one pixel (y) among eight upper pixels 2030 of the data block 2040 may be reconfigured using neighboring pixels a1, b1, and c1 in the pixels 2020 of the previous line and neighboring pixels a2, b2, and c2 in the lower pixels 2010 of the data block 2040. For example, the neighboring pixels in the pixels 2020 of the previous line and the neighboring pixels a2, b2, and c2 in the lower pixels 2010 mean pixels adjacent to the pixel y to be reconfigured.

The pixel y may be reconfigured by discovering the closest value or edge using interpolation between the neighboring pixels. For example, absolute values for the combinations (original characters 1, 2, 3) of the neighboring pixels a1, b1, and c1 in the pixels 2020 of the previous line and the neighboring pixels a2, b2, and c2 in the lower pixels 2010 may be calculated. The absolute values may be calculated by absolute values (|a1-c2|, |b1-b2|, |c1-a2|) for the differential values between two pixel values.

According to an embodiment of the present disclosure, the encoder may select the minimum value among the absolute values calculated for each of the three combinations. The absolute value may be an example indicating the distance between the two pixels constituting the corresponding combination. For example, the absolute value being minimum indicates that the distance between the two pixels constituting the corresponding combination is shortest. In this case, when the pixel y is reconfigured using interpolation between the two pixels whose absolute values are minimum, the error rate by encoding the data block may be minimized.

For example, when a1 and c2 have the minimum absolute value, the value of pixel y may be reconfigured using interpolation between a1 and c2. In this case, four possible values may be selected using different types of interpolation so that pixel y may be configured best.

The following Table 3 defines an example for values reconfigurable using different types of interpolation. It is assumed that interpolation between a1 (pixel value of previous line) and c2 (lower pixel value) is used in reconfiguring the value of pixel y in Table 3.

TABLE 3

| Interpolation index | Reconfigured pixel value |
|---|---|
| 00 | a1 |
| 01 | c2 |
| 10 | $\frac{3 a + b}{4}$ |
| 11 | $\frac{a + 3 b}{4}$ |

According to Table 3 above, the encoder may select two pixels with the minimum absolute value and may compute reconfigured pixel values using different types of interpolation based on the two selected pixels. For example, the encoder 600 may obtain an interpolation index for selecting the value that enables best configuration of the value closest to pixel y, i.e., pixel y, among the obtained pixel values.

According to an embodiment of the present disclosure, the encoder 600 obtains every two bits of interpolation indexes corresponding to each of eight upper pixels. In this case, the encoder 600 may configure a 16-bit interpolation index set (Interpolation indices) by the interpolation indexes obtained per upper pixel. The encoder 600 may update the RV transmission with the four representative values from the lower pixels.

FIG. 21 illustrates a compressed bitstream obtained by performing encoding in compression mode 3 according to an embodiment of the present disclosure.

Referring to FIG. 21, the compressed bitstream may include compression mode selection information (Mode selection) 2110, a bitmap 2120, interpolation indexes 2130, and error correction information 2140 and 2150.

The compression mode selection information 2110 may be two-bit information for indicating that the data block has been encoded in compression mode 3. The bitmap 2120 may be 16-bit information for identifying the seed assigned to each of the lower pixels. The interpolation indexes 2130 may be 16-bit information for guiding the upper pixel value to be reconfigured through interpolation. The error correction information 2140 and 2150 is obtained per group and does not exceed 62 bits.

For example, when four groups configured by eight lower pixels are grouped into two pairs, the encoder 600 may configure 31-bit error correction information corresponding to each grouped pair. The 31-bit error correction information may include an 18-bit representative value 2142 and 2152, six-bit direction information 2144 and 2154, and seven-bit length information 2146 and 2156.

Fourth described is configuring compressed data using compression mode 4 that is one of various compression schemes.

Compression mode 4 may perform an encoding operation in a similar way to compression mode 3. For example, in compression mode 4, information for reconfiguring eight upper pixels constituting one data block may be defined to be different from that in compression mode 3. For example, in compression mode 3, the upper pixels are reconfigured using interpolation, but in compression mode 4, the upper pixels may be reconfigured using a bitmap.

In sum, while the compressed bitstream as per compression mode 3 may include an interpolation index set for reconfiguring the upper pixels by interpolation, the compressed bitstream as per compression mode 4 may include a bitmap for reconfiguring the upper pixels.

In this case, the compressed bitstream by compression mode 4 may contain two-bit mode selection information, 16-bit bitmap information, and 62-bit error correction information. For reference, the compressed bitstream by compression mode 3 may include two-bit mode selection information, eight-bit bitmap information, eight-bit interpolation index set, and 62-bit error correction information.

According to an embodiment of the present disclosure, in compression mode 4 as proposed, two clustering schemes may come in use to classify 16 pixels (eight upper pixels and eight lower pixels) constituting one data block into four clusters. For example, in compression mode 4 proposed, a modified K-means clustering scheme and a modified principal component analysis scheme (hereinafter, “PCA scheme”) may be used for clustering pixels.

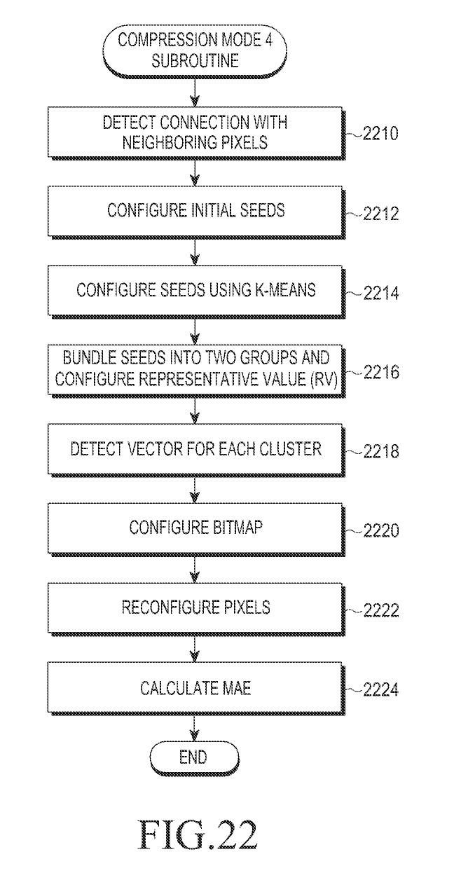

FIG. 22 is a flowchart illustrating a subroutine as per compression mode 4 in an encoder according to an embodiment of the present disclosure.

Referring to FIG. 22, one data block may include 16 (=8×2) pixels including eight upper pixels and eight lower pixels. The one data block may be encoded at a compression rate of 4:1.

According to an embodiment of the present disclosure, in operation 2210, the encoder 600 may detect a connection between each pixel constituting the data block and adjacent neighboring pixels. The encoder 600 may select the values of initial seeds considering the similarity between the reconfigured neighboring pixels and pixels (upper pixels and lower pixels) constituting the data block by detecting the connection. The reconfigured pixels may be pixels constituting the data block that has been encoded earlier than the corresponding data block. The reconfigured neighboring pixels may be pixels adjacent to each pixel constituting the data block to be encoded among the reconfigured pixels.

According to an embodiment of the present disclosure, in operation 2212, the encoder 600 may configure initial seeds considering an overlap that may arise in one data block including multiple lower pixels and multiple upper pixels. For example, the encoder 600 may configure the initial seeds based on the connection with the neighboring pixels detected corresponding to each pixel constituting the data block. When the initial seeds are configured based on the connection with the neighboring pixels, the encoder 600 may obtain initial seed values considering the similarity between the reconfigured neighboring pixels and the pixels of the data block.

According to an embodiment of the present disclosure, configuring the initial seed value considering the connection with the neighboring pixels may be a simplified scheme used to reduce complexity and time upon classifying the pixels constituting the data block.

According to an embodiment of the present disclosure, the encoder 600 may randomly select the initial seed values without considering other conditions, e.g., the connection with the neighboring pixels. This method may be a simplified way used to reduce complexity and time upon classifying pixels, but fails to consider simplicity with the neighboring pixels.

For example, the initial seeds may correspond to four clusters classifying each of the eight upper pixels and eight lower pixels. The initial seeds, i.e., the four clusters, each may be assigned with an initial seed value.

According to an embodiment of the present disclosure, in operation 2214, the encoder 600 may configure seeds using a standard K-means algorithm. For example, the pixels classified into four initial seeds may be selected as initial seeds for a modified standard K-means algorithm. Use of the initial seeds may prevent the worst scenario in which the encoder 600 indefinitely repeats the standard K-means algorithm to obtain a complete representative value for each cluster.

According to an embodiment of the present disclosure, the modified standard K-means algorithm may definitely determine the best representative values respectively representing the four clusters corresponding to each of the upper pixels and the lower pixels. For this, the encoder 600 may repeat the modified standard K-means algorithm four times corresponding to the upper or lower pixels using the initial seeds. The encoder 600 may definitely determine the best representative value representing one cluster whenever performing the modified standard K-means algorithm.

According to an embodiment of the present disclosure, the encoder 600 may also definitely determine the representative value for each of the four clusters by a modified PCA scheme, not by the standard K-means algorithm. For example, the PCA scheme may be a simple scheme for computing an average for luminance channel of pixels in compression mode 3. To that end, in the modified PCA scheme, the luminance coefficient of the pixels constituting one data block may be computed using standard YCbCr color transform.

For example, when 16 pixels including eight upper pixels and eight lower pixels are encoded, the encoder 600 may classify each of the eight upper pixels and eight lower pixels into two clusters each including four pixels. The encoder 600 may classify each of the two clusters into two sub cluster each including two pixels. For example, the encoder 600 may classify the eight upper pixels into four sub clusters each having two upper pixels and the eight lower pixels into four sub clusters each having two lower pixels.

Specifically, the encoder 600 may classify the eight upper pixels into two clusters with respect to a threshold obtained by an average of the pixel values. The encoder 600 may classify the upper pixels classified into the two clusters into two sub clusters with respect to a threshold obtained by the average of the pixel values in the cluster. In this case, the encoder 600 may classify the eight upper pixels into four sub clusters each including two upper pixels.

The encoder 600 may classify the eight lower pixels into two clusters with respect to a threshold obtained by an average of the pixel values. The encoder 600 may classify the lower pixels classified into the two clusters into two sub clusters with respect to a threshold obtained by the average of the pixel values in the cluster. In this case, the encoder 600 may classify the eight lower pixels into four sub clusters each including two lower pixels.

According to an embodiment of the present disclosure, the encoder 600 may configure seeds by four sub clusters classifying the upper pixels and four sub clusters classifying the lower pixels.

For example, the encoder 600 may assign a seed to each of the four sub clusters classifying the upper pixels using “00,” “01,” “10,” “11,” or “HH,” “HL,” “LH,” and “LL.” The encoder 600 may also assign a seed to each of the four sub clusters classifying the lower pixels using “00,” “01,” “10,” “11,” or “HH,” “HL,” “LH,” and “LL.”

“00” or “HH” may mean that the pixel value has been determined to have a value larger than the average in the two times of separation. “01” or “HL” may mean that the pixel value has been determined to be larger than the average in the first separation, but has been determined to be less than the average. “10” or “LH” may mean that the pixel value has been determined to be less than the average in the first separation, but has been determined to be more than the average. “11” or “LL” may mean that the pixel value has been determined to have a value less than the average in the two times of separation.

According to an embodiment of the present disclosure, in operation 2216, the encoder 600 may obtain representative values for the four clusters classified corresponding to each of the upper pixels and lower pixels. The encoder 600 may group the four obtained representative values into two pairs. The encoder 600 may compute the representative value of the corresponding pair by the mean value between two representative values constituting the pair by the grouping.

For example, the encoder 600 may obtain two pairs corresponding to the upper pixels and representative value corresponding to the corresponding pair and may obtain two pairs corresponding to the lower pixels and representative value corresponding to the corresponding pair. For example, since the mean value is computed for each pair, the encoder 600 may obtain two mean values corresponding to the upper pixels and two mean values corresponding to the lower pixels.

According to an embodiment of the present disclosure, in operation 2218, the encoder 600 may detect the vector formed as the original representative value from the mean value obtained corresponding to each pair.

According to an embodiment of the present disclosure, in operation 2220, the encoder 600 may configure a bitmap based on the configured seeds and may configure error correction information by the detected vectors.

For example, the encoder 600 may configure a bitmap corresponding to one data block with the seed assigned to each group, i.e., “00,” “01,” “10,” “11,” or “HH,” “HL,” “LH,” and “LL.” The configured bitmap may include an eight-bit bitmap for the upper pixels and an eight-bit bitmap for the lower pixels. In order to minimize the amount of information constituting the bitmap, the seed may be assigned to each group using “00,” “01,” “10,” and “11.”

According to an embodiment of the present disclosure, the encoder 600 may configure error correction information including the information on the vector and the RV. The information on the vector may include direction information and length information.

According to an embodiment of the present disclosure, to meet the compression rate of 4:1, the error correction information may be configured not to exceed 62 bits.

To that end, two schemes may be taken into account. For example, there may be a scheme using vector quantization and a scheme using scalar quantization. This has been already described above in connection with compression mode 3, and no further description is given hereinafter.

According to an embodiment of the present disclosure, the encoder 600 may configure a compressed bitstream by the configured bitmap and seed value or RV value. In operation 2222, the encoder 600 may reconfigure the upper pixels and lower pixels constituting the data block based on the compressed bitstream. In operation 2224, the encoder 600 may calculate an error rate MAE by the reconfigured lower and upper pixels and the pixels constituting the original data block.

FIG. 23 illustrates a compressed bitstream obtained by performing encoding in compression mode 4 according to an embodiment of the present disclosure.

Referring to FIG. 23, the compressed bitstream may include compression mode selection information (Mode selection) 2310, a bitmap 2320, and error correction information 2330 and 2340.

The compression mode selection information 2310 may be two-bit information for indicating that the data block has been encoded in compression mode 4. The bitmap 2320 may be 32-bit information for identifying the seed assigned to each of the upper pixels and lower pixels. The error correction information 2330 and 2340 is obtained per group and does not exceed 62 bits.

For example, when four groups configured by eight lower pixels are grouped into two pairs, the encoder may configure 31-bit error correction information corresponding to each grouped pair. The 31-bit error correction information may include an 18-bit representative value 2332 and 2342, six-bit direction information 2334 and 2344, and seven-bit length information 2336 and 2346.

Although specific embodiments of the present disclosure have been described above, various changes may be made thereto without departing from the scope of the present disclosure. Thus, the scope of the present disclosure should not be limited to the above-described embodiments of the present disclosure, and should rather be defined by the following claims and equivalents thereof.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A device comprising:
an encoding module configured to encode at least one data block based on each of a plurality of specified compression modes;
a reconfiguration module configured to reconfigure the at least one data block corresponding to each of the plurality of specified compression modes based at least in part on each of the plurality of specified compression modes;
a determination module configured to determine an inter-data difference corresponding to each of the plurality of specified compression modes based on the at least one data block and a data block obtained by reconfiguring the at least one data block; and
a selection module configured to select at least one compression mode from the plurality of specified compression modes based at least in part on each of the inter-data difference.

2. The device of claim 1, wherein the encoding module is further configured to:
split one image frame into a certain size to obtain the at least one data block, and
encode the obtained at least one data block based on each of the plurality of specified compression modes based on a neighboring value and a representative value obtained by encoding neighboring pixels positioned adjacent to the obtained at least one data block.

3. The device of claim 2, wherein the reconfiguration module is further configured to reconfigure the at least one data block corresponding to each of the plurality of specified compression modes based on per-compression mode compressed bitstreams output by the encoding module.

4. The device of claim 3, wherein the determination module is further configured to:
calculate an error rate corresponding to each of the plurality of specified compression modes by the data block reconfigured corresponding to each of the plurality of specified compression modes and the at least one data block, and
output a selection signal of a compression mode having a minimum error rate among error rates calculated corresponding to each of the plurality of specified compression modes.

5. The device of claim 4, wherein the selection module is further configured to select one compressed bitstream by a selection signal output by the determination module among compressed bitstreams corresponding to each of the plurality of specified compression modes output from the encoding module.

6. The device of claim 5, further comprising:
a memory configured to:
record a certain number of representative values, and
record at least one of a representative value table in which the recorded representative values are updated by a compressed bitstream selected by the selection module and a prediction table including neighboring pixel values and certain color values.

7. The device of claim 1,
wherein the plurality of specified compression modes comprise a spatial prediction scheme, a codebook indexing scheme, a 4-level vector quantization block truncation coding (VQ-BTC) with interpolation scheme, and a modified 4-level VQ-BTC scheme, and
wherein the compressed bitstream generated for each of the plurality of specified compression modes includes mode identification information for identifying a corresponding compression mode.

8. The device of claim 7, wherein the encoding module is further configured to, when the at least one compression mode comprises the spatial prediction scheme:
sequentially select one sub data block from a plurality of sub data blocks,
determine an optimal prediction direction for the selected one sub data block among a plurality of certain prediction directions,
identify a number of erroneous sub data blocks with an error among the plurality of sub data blocks, and
generate a compressed bitstream to include error correction encoding information corresponding to the identified number of sub data blocks and information on the optimal prediction direction determined per sub data block.

9. The device of claim 7, wherein the encoding module is further configured to, when the at least one compression mode comprises the codebook indexing scheme:
perform indexing on each of pixel values constituting the at least one data block based on a prediction table including the representative value table to configure representative value table index information,
configure error correction information by direction information and length information defining a vector adjusting, to a target pixel value, a pixel value of a pixel with a maximum error value among pixels constituting the at least one data block, and
generate a compressed bitstream to include the representative value table index information and the error correction information.

10. The device of claim 7, wherein the encoding module is further configured to, when the at least one compression mode comprises the 4-level VQ-BTC scheme with interpolation:
classify a certain number of lower pixels constituting the at least one data block into a certain number of clusters with respect to a unique threshold,
configure a bitmap considering a seed by which each of the certain number of lower pixels is classified,
configure the certain number of clusters into a plurality of groups and configure error correction information for the certain number of lower pixels per group,
configure interpolation information for reconfiguring a certain number of upper pixels constituting the one data block by interpolation based on pixels constituting a previous line of the one data block and the certain number of lower pixels, and
generate a compressed bitstream to include the configured bitmap, error correction information, and interpolation information.

11. The device of claim 7, wherein the encoding module is further configured to, when the at least one compression mode comprises the modified 4-level VQ-BTC scheme:
classify a certain number of upper pixels and a certain number of lower pixels constituting the at least one data block into a certain number of clusters with respect to a unique threshold,
configure a bitmap considering a seed by which each of the certain number of upper pixels and the certain number of lower pixels is classified,
configure the certain number of clusters into a plurality of groups and configure error correction information for the pixels per group, and
generate a compressed bitstream to include the configured bitmap and error correction information.

12. A method comprising:
encoding at least one data block based on each of a plurality of specified compression modes;
reconfiguring the at least one data block corresponding to each of the plurality of specified compression modes based on compressed bitstreams generated by each of the plurality of specified compression modes;
calculating an inter-data difference corresponding to each of the plurality of specified compression modes based on the at least one data block reconfigured corresponding to each of the plurality of specified compression modes and the at least one data block; and
selecting a compression mode with a minimum difference among differences calculated corresponding to each of the plurality of specified compression modes.

13. The method of claim 12, wherein the encoding of the at least one data block comprises:
splitting one image frame into a certain size to obtain the at least one data block; and
encoding the obtained at least one data block based on each of the plurality of specified compression modes based on a neighboring value and a representative value obtained by encoding neighboring pixels positioned adjacent to the obtained at least one data block.

14. The method of claim 13, wherein the reconfiguring of the at least one data block comprises reconfiguring the at least one data block corresponding to each of the plurality of specified compression modes based on per-compression mode compressed bitstreams output by the encoding.

15. The method of claim 14, wherein the calculating of the inter-data difference comprises calculating an error rate corresponding to each of the plurality of specified compression modes by the data block reconfigured corresponding to each of the plurality of specified compression modes and the at least one data block.

16. The method of claim 15, wherein the selecting of the compression mode with the minimum difference comprises:
determining a compression mode having a minimum error rate among error rates calculated corresponding to each of the plurality of specified compression modes; and
selecting a compressed bitstream corresponding to the determined compression mode among compressed bitstreams corresponding to each of the plurality of specified compression modes output by the encoding.

17. The method of claim 16, further comprising:
at least one of updating a certain number of representative values recorded in a representative value table with the selected compressed bitstream and generating a prediction table including neighboring pixel values and certain color values.

18. The method of claim 15,
wherein the plurality of specified compression modes comprise a spatial prediction scheme, a codebook indexing scheme, a 4-level VQ-BTC with interpolation scheme, and a modified 4-level VQ-BTC scheme, and
wherein the compressed bitstream generated for each of the plurality of specified compression modes includes mode identification information for identifying a corresponding compression mode.

19. The method of claim 18, wherein, when the compression mode comprises the spatial prediction scheme, the encoding of the obtained at least one data block comprises:
sequentially selecting one sub data block from a plurality of sub data blocks,
determining an optimal prediction direction for the selected one sub data block among a plurality of certain prediction directions,
identifying a number of erroneous sub data blocks with an error among the plurality of sub data blocks, and
generating a compressed bitstream to include error correction encoding information corresponding to the identified number of sub data blocks and information on the optimal prediction direction determined per sub data block.

20. The method of claim 18, wherein, when the compression mode comprises the codebook indexing scheme, the encoding of the obtained at least one data block comprises:
performing indexing on each of pixel values constituting the at least one data block based on a prediction table including the representative value table to configure representative value table index information,
configuring error correction information by direction information and length information defining a vector adjusting, to a target pixel value, a pixel value of a pixel with a maximum error value among pixels constituting the at least one data block, and
generating a compressed bitstream to include the representative value table index information and the error correction information.

21. The method of claim 18, wherein, when the compression mode comprises the 4-level VQ-BTC scheme with interpolation, the encoding of the obtained at least one data block comprises:
classifying a certain number of lower pixels constituting the at least one data block into a certain number of clusters with respect to a unique threshold,
configuring a bitmap considering a seed by which each of the certain number of lower pixels is classified,
configuring the certain number of clusters into a plurality of groups and configure error correction information for the certain number of lower pixels per group,
configuring interpolation information for reconfiguring a certain number of upper pixels constituting the one data block by interpolation based on pixels constituting a previous line of the one data block and the certain number of lower pixels, and
generating a compressed bitstream to include the configured bitmap, error correction information, and interpolation information.

22. The method of claim 18, wherein, when the compression mode comprises the modified 4-level VQ-BTC scheme, the encoding of the obtained at least one data block comprises:
classifying a certain number of upper pixels and a certain number of lower pixels constituting the at least one data block into a certain number of clusters with respect to a unique threshold,
configuring a bitmap considering a seed by which each of the certain number of upper pixels and the certain number of lower pixels is classified,
configuring the certain number of clusters into a plurality of groups and configure error correction information for the pixels per group, and
generating a compressed bitstream to include the configured bitmap and error correction information.

23. At least one non-transitory computer readable storage medium for storing a computer program of instructions configured to be readable by at least one processor for instructing the at least one processor to execute a computer process for performing the method of claim 12.
